(19) United States
(12) Patent Application Publication
(10) Pub. No.: US 2019/0236699 A1
(43) Pub. Date: Aug. 1, 2019

(54) SYSTEM AND METHOD FOR REFUNDING REAL PROPERTY TAXES USING EASEMENTS, OPTIONS AND THE CAPITAL MARKETS

(71) Applicant: Dale C. Newton, Orlando, FL (US)

(72) Inventor: Dale C. Newton, Orlando, FL (US)

(21) Appl. No.: 16/258,558

(22) Filed: Jan. 26, 2019

Related U.S. Application Data
(60) Provisional application No. 62/622,529, filed on Jan. 26, 2018.

(51) Int. Cl. G06Q 40/04; G06Q 50/16

(52) U.S. Cl. CPC G06Q 40/04; G06Q 50/16

(57) ABSTRACT

The present invention is directed to a system and a method of using property taxes to create an asset (property tax easement), which has a fair market value, that can serve as an underlying instrument or security for purpose of linking it to a new type of option (property tax put or call option) that can be bought, sold, and/or traded on, preferably, a major publicly-traded exchange. The present invention includes several, most or all of the following: a property tax easement, a Multi-Listing Subscription-type (MLS-type) listing, property tax options, a publicly-traded market exchange, and a Property Tax Refund Program that—collectively, provides the owners of residential real estate property(ies) and/or commercial real estate property(ies) with the means to potentially obtain a property tax refund each and every year.

### CROSS-REFERENCE TO RELATED APPLICATION

The present application is a nonprovisional application of and claims the priority benefit of U.S. Provisional Patent Application Ser. No. 62/622,529, filed on Jan. 26, 2018 and entitled “System and Method for Refunding Property Taxes Using Options and the Capital Markets,” which is incorporated herein by reference in its entirety.

### BACKGROUND OF THE INVENTION

### Field of the Invention

The present invention generally relates to real property taxes, capital markets, and systems and methods related to real property taxes and capital markets. More specifically, the present invention is directed to a system and a method of using real property taxes to create an intangible asset (property tax easement), which has a fair market value, that can serve as an underlying instrument or security for the purpose of linking it to a new type of option (property tax put or call option) that can be bought, sold, and/or traded on, preferably, a major publicly-traded exchange, like the Chicago Board of Options Exchange (CBOE) or Euronext, just like any other commodity.

### Description of the Related Art

Many people are very familiar with the process of having to file their federal, state, and/or local tax returns each year and hoping to receive a tax refund check back from one of these government entities.

Real property taxes represent one of the key “building blocks” of a modem capitalist socioeconomic system. Governments levy property taxes on real estate property and use the collected property tax revenues in support of local government functions.

Typically, every municipality, city, county, and state is authorized and granted the power to raise or lower taxes, such as ad valorem or real property taxes. This authority is issued pursuant to the sovereign power and authority of a local or state government entity, such as a legislative body. On a national level, the annual property tax revenue raised by a local or state government can be significant and total in the millions (even billions) of dollars each year. These funds are used to support elementary, middle school, high school, and upper level college education—as well as health care, fire, safety, police, transportation, welfare, and many other government-sponsored programs.

Real property taxes represent a reliable, steady, predictable, stream of cash flows that have a very high probability of being paid to a local government entity at a certain time on a regular annual basis. However, at times, the amount of revenue tax dollars expected to be received each year from property taxes is inadequate and has led to major financial crises for some cities and counties. The Commonwealth of Puerto Rico (2017) and different cities and counties, such as Detroit, Mich. (2013), Stockton, Calif. (2012), Jefferson County (Birmingham, Ala., 2011), and Orange County, Calif. (1994), have filed for bankruptcy during the past few decades and recent years.

In addition, natural disasters due to a hurricane or earthquake can often result in unexpected massive property damage and significant loss of local property tax revenues. Local government officials and real property owners affected by disasters may seek low-interest rate loans and relief assistance packages from the federal and state governments, private donations, other neighboring states, and non-profits entities. However, this process can take weeks, months, if not years to receive all the funding needed to rebuild and to restore a home, building, city, or community to its former state. After a hurricane occurs, significant flooding often affects individual property owners in the affected area. Not all property owners have flood insurance or can afford to pay the high insurance premiums for flood insurance. Despite the National Flood Insurance program that helps to reduce the overall costs of flood insurance, there are an increasing number of cities and coastal communities becoming prone to flooding and causing further erosion of the tax base.

Elected government officials are sometimes reluctant to raise real property taxes out of fear of a taxpayer revolt, being voted out of office, or creating major population shifts and prompting the relocation of businesses to more tax-friendly cities and states. If and when this occurs, the ability of a local government to balance its budget can be even more challenging since many governments largely depend on a stable and preferably growing population and number of businesses to help maintain its revenue base.

As such, there is a need for both individual real property owners and local county and governmental officials to consider other alternative sources of capital.

U.S. Pat. No. 6,769,691 entitled “Apparatus for financial investment education and entertainment,” issued to Aaron Kim, refers to an educational asset management board game that involves “buying put and call options”, “paying a designated amount of property tax”, and a “plurality of players [who] compete”.

www.navitax.ca is a property tax consulting firm that focuses on obtaining property tax refunds for industrial buildings/property by appealing the taxes owed and striving to obtain a lowered assessment.

Property Tax Refund Services of Illinois is another entity that presumably provides real property tax refund services.

The National Tax Lien Association

Letter from The National Tax Lien Association dated 16 Apr. 2014 in response to an article written by Bill Hogan and published April 2014 by the AARP entitled, “Predators Target Homes of Older Americans” highlights the problem of an increasing number of foreclosures due to unpaid delinquent taxes.

According to the fundamental equation of accounting, Liabilities=Assets, the present invention uses this equation and a similar equation:

Contingent Liability=Contingent Asset

Both of these two equations are well-known, used, and widely recognized throughout the professional disciplines and the prior art published literature by the professionals who practice in the field of accounting, finance, economics, banking, real estate law, tax law, and taxation.

Both the prior art and the present invention teach that every time a liability is created, there must also be an asset simultaneously created which can be claimed by the party on the other side of the transaction.

Based upon the terms “real property taxes,” the present invention claims that real property taxes owed by the real property owner related to a given specific real property, such as a residential or commercial building, represent a contingent liability.

### Real Estate

According to the National Tax Lien Association, the current total size of the U.S. property tax liability market is estimated to be about $450 billion based on the amount that owners of residential and commercial property pay each year to their local government entities. It is believed that the majority of the collected funds are infrequently (possibly seldom) ever refunded back to the individual business owner or the individual person who has to pay them each year.

Therein lies the crux of the real-world problem: The payment of property taxes is a zero-sum game.

Someone has to win and someone else has to lose.

By definition, there is always a winner and a loser in every zero sum game. It is typically a game that usually involves only two players—an individual taxpayer (or business) and the local government tax authority (i.e., tax collector and/or tax assessor). The rules of the game are determined by various policies, regulations, laws, and statutes enacted and promulgated by federal, state, and local government authorities, their respective state and local Departments of Revenue, taxing authorities, and the Internal Revenue Service.

The game of chess is a game that involves two competing players who each have a certain number and type of chess pieces that can only be moved according to certain rules of the game. Chess pieces include the king, queen, knight, rook, bishop, and pawn. Winning the game of chess requires a player focusing and engaging in strategic thinking, deploying various chess pieces in different ways during certain phases of the game, and being able to “take a position” that will optimize their chances of ultimately winning the game. Chess games can be played by both individual human and non-human competitors.

Under the current existing tax system, the payment of property taxes is a zero-sum game because individual taxpayers routinely (and usually) do not expect to receive any refund of their property taxes back—once they've been paid to a local tax collector or tax authority.

In order for either a business or an individual human taxpayer to become a winner in the current existing property tax zero-sum game, they have to either create a “new game related to property taxes” or be given an opportunity to participate in such a game.

### Accounting

Throughout the world of business and finance, there are at least two well-recognized standards adopted by the accounting professionals and these standards are referred to as the generally accepted accounting principles (GAAP) and the generally accepted accounting rules of procedure (GAARP).

If you look at any corporate balance sheet, it is divided up into two parts: an “Assets Section” and “Liabilities Section”. Under the generally accepted accounting rules of procedure (GAARP), both sides have to always be in balance according to a certain fundamental accounting equation.

Whether speaking about a business or an individual, there is one main fundamental equation of accounting:

Assets=Liabilities+Shareholder's Equity (Equation 1)

To keep things simple, if we ignore shareholder's equity—then, according to the rules of accounting, every asset has to be offset or balanced by a liability. A liability is defined as a debt that is owed.

There are both “tangible assets” and “intangible assets” shown on a balance sheet. For example, money is a line item that's listed, categorized as an asset, and shown in the form of “cash” under the Assets section of a balance sheet. Under this section, additional separate line items and categories are listed for land, supplies, accounts receivable, inventory, property plant, equipment, short-term investments, pre-paid items, intangible assets, etc. Intangible assets are not physical in nature. Examples of intangible assets include patents, copyrights, trademarks, easements, goodwill, brand, etc.

Under the Liabilities section, there are usually both current liabilities (which represent debt that must be paid within the next twelve months) and noncurrent liabilities (which represent debt that is not due or owed within the current accounting year). Examples of current liabilities include accounts payable, wages payable, dividend payable, interest payable, etc. Examples of noncurrent liabilities include bonds payable, long-term lease obligations, pension fund liability, long term debt, deferred income tax liabilities, etc.

However, on many corporate balance sheets, property taxes are not identified as a unique, listed, separately categorized, line item. Rather, real property taxes tend to be lumped together and listed as a line item under the broader general heading of “taxes.” Nevertheless, real property taxes are real and do represent a significant important source of revenue that local county government entities and taxing authorities depend upon.

However, the amount of the real property taxes liability anticipated and expected to be owed in the future (i.e., next year) is not known in advance and cannot be known—unless and until after a property assessment has been performed on a given subject real estate property. Otherwise, any annual property tax liability expected to be owed beyond the next twelve months would have to be disclosed, listed, and categorized—more specifically, as a contingent liability or, in some cases, perhaps as a provision.

According to GAAP and GAARP, whenever there exists a liability that is both known, is probable, can be reasonably estimated, and is expected to be owed and paid in the future—then, this debt obligation should be reflected on the balance sheet under the Liabilities Section and categorized as a “contingent liability.”

A search of the public tax records regarding a real estate property will usually reveal the annual assessed market value of that property and the property taxes that were assessed and paid during the past several years. The amount of real property taxes owed each year in the future cannot be accurately calculated or predicted with certainty.

However, based on the past historical data, it is possible to calculate an average arithmetical (mean) value and standard deviation of the property taxes and use this computed value along with statistics and probability theory to arrive at an estimate of the property taxes that could be owed in the future as well as the probability of this occurrence.

For example—if one were to assume that the annual real property taxes owed on their residential property will be $1000 for the next year or thirty years, then this represents a $1K or a $30K contingent property tax liability, respectively—that, at least one owner of the subject property would ultimately be obligated to pay.

With regards to residential and commercial real estate property, it is commonly known throughout the industry that an online or printed directory called a Multi-Listing Subscription (MLS) is a primary resource that many brokers, realtors, and real estate agents use to quickly and easily identify all commercial and residential properties available for prospective buyers and sellers. The directory covers different local and regional geographic locations and contains a wealth of information about each property such as the current property taxes, address, listing price, etc.

A review of the MLS typically reveals the annual amount of property taxes owed (or paid) for a given real estate property or parcel of land listed for sale. The listed property is often associated with the name of the property owner, a Tax ID, a property address, and/or a legal description that identifies the listed property being taxed by the taxing authority. The owner of the property has the legal duty, obligation, and responsibility to pay the taxes owed on the property to the local tax collector.

With regards to purchasing residential and commercial real estate property, it is commonly known throughout the industry that one can use a lease purchase option agreement to acquire real estate property. The real estate property acquired may consist of both tangible assets and intangible assets. It is well known throughout the industry that a property owner can take a noncash expense, called a depreciation expense related to the “wear and tear” associated with their physical residential and commercial property, and claim it as a deduction on their business or personal tax return. Likewise, as is similar with taking a depreciation expense—it is also well known throughout the industry that the owner of intangible property assets, such as patents, copyrights, trademarks, and easements, can claim an amortization expense on their business or personal tax return. If the amount of the expense is greater than their earned income, then it is possible for the owner of an intangible property asset to file certain IRS Forms (i.e., 1035, 1149) and seek to claim a refund related to their individual personal or business tax returns. The refund can arise as a result of a net operating loss (NOL) being generated and can be used to request and claim a refund for prior years called a loss carryback. However, with the recent passage of the Tax Cuts and Jobs Act (TCJA), the NOL may now only be generated and applied as a loss carry forward and used to offset future expected taxable income. Alternatively, the owner of an intangible property asset may choose to file IRS Form 8283 and seek to donate it to an eligible tax-exempt organization, claim a deduction, and then use the deduction as a means of “refunding their real property taxes” or offsetting and reducing the amount of taxes owed related on their individual personal or business tax returns.

### Stock Options

Options are well-understood, routine and conventionally used by professionals and those skilled in the art of real estate such as using a lease-purchase option to buy some land or a building. Options are also well-understood, routine and conventionally used by professionals and those skilled in the art of finance and options-exchange, such as CBOE and Euronext. Options are also viewed as a zero-sum game.

A stock option contract gives the buyer of the option the right to buy or sell 100 shares of the underlying stock at a predetermined price on or before the expiration date.

The typical elements of a stock option contract are:
the price of the option which is called the premium. This represents what the buyer of the stock option would have to pay to the seller of the option;
the predetermined price known as the strike price (or the exercise price);
the stock price (or the market price) of the stock; and
there is also an expiration date.

The buyer of a call option contract will have the right but not the obligation to buy the underlying stock at the strike price (exercise price) and will typically exercise the call option whenever the stock price is higher than the exercise price.

On a traditional publicly-traded (or private) exchange, there are option chains which represent a range of different strike prices that are available. The difference between each strike price is standardized (i.e., $1, $2, $5, $10, etc.) and often based on the price of the stock.

For example, assume that Company XYZ is a publicly-traded company whose shares are currently at $90 per share. Company XYZ has a call stock option whose strike price is $100 (USD).

Believing that the share price of the XYZ stock will increase over the next year and reach $120 per share, an investor decides to buy a long call XYZ option. The investor will pay a premium of $10 per contract to a seller for the option position.

If, upon expiration, the stock price is equal to the strike price, then the investor is “at the money” and the investor will not exercise the call option. In this case, the investor will lose the premium they invested and the option will expire worthless. If the stock price falls below the current share price, then the option will not be exercised and the investor will have lost the premium they paid for the option. However, if the stock price rises higher than the strike price of $100 and reaches $120, then the investor will exercise their option and take their profit.

The break-even price for the stock is strike price+premium or $100+$10=$110 (USD). If the price per share reaches $110, then the investor will have a profit of $10 (USD) but an overall net profit of $0 (USD). If the price per share reaches $120, then the investor will have a profit of $20 (USD) and an overall net profit of $10 (USD). The maximum possible loss is $10 and the maximum possible gain is unlimited.

FIG. 11 illustrates a stock long call option contract payoff graph.

An option is a standardized contract that gives a person the right to buy or sell a certain amount of an underlying real or financial asset at a specified price for a given time period. There are both put and call options. Puts and calls option positions are created by individual investors and can be traded on a publicly-traded exchange. A put and a call is a type of derivative security whose value is derived from the changes in the price of the underlying real or financial asset. According to the Statement of Financial Accounting Standards No. 133 “Accounting for Derivative Instruments and Hedging Activities” (June 1998), an underlying is a specified interest rate, security price, commodity price, foreign exchange rate, index of prices or rates, or other variable. An underlying may be a price or rate of an asset or liability but is not the asset or liability itself. An underlying may be any variable whose changes are observable or otherwise objectively verifiable. A notional amount is a number of currency units, shares, bushels, pounds, or other units specified in the contract. The settlement of a derivative instrument with a notional amount is determined by interaction of that notional amount with the underlying.

The buyer of an option has the right to buy (a call option) or to sell (put option) an underlying asset at a fixed price (strike price or exercise price) for a given period of time before the option expires. The buyer of the call option wants the price of the underlying asset to go up. The seller of the call option wants the price of the underlying asset to go down. If the price of the underlying asset goes above the option's strike price, the option holder will purchase the asset at the strike price and then sell it at the higher market price, making a profit.

The option writer must sell the asset at the strike price (which is lower than the asset's market price). If the seller does not already own the underlying asset, then the seller will have to purchase it at the higher market price. The option seller receives the option premium upfront from the buyer of an option. The option seller is obligated to sell (in the case of a call option) or to buy (in the case of a put option) an underlying asset according to the terms of the option contract. If exercising the option would be unprofitable for the option buyer, then they have the right to walk away from the transaction. However, an option seller cannot walk away from their contractual obligation.

The present invention teaches that, with respect to the subject matter of property taxes, there must exist a contingent asset that serves as a balance to the contingent real property tax liabilities.

The present invention further teaches that, based upon the accounting equation itself, the existence of this contingent asset demands that it have a value that is at least equal to the value of the contingent liability.

The prior art teaches and discloses a connection between property taxes and a property tax lien. More specifically, the prior art discloses a process of placing a property tax lien on a given parcel of land. The property tax lien is placed on the property if and when the property taxes owed have become past due, delinquent, or failed to have been paid by the property owner. This process can result in the property being subjected to a tax lien sale and being sold off to an investor who is the highest bidder at a tax lien certificate sale auction. Usually, the property owner has a certain period of time (such as two years) to exercise a right of redemption and acquire their property back upon paying all interest, fees, charges, and the property taxes owed on the property. This process involving property taxes and a property tax lien on the subject property is well-known, routine, and a commonly understood means used by a local or state government to collect taxes.

Another embodiment of the property-specific geographic address trademark is a three-word (3-word) address mapping method and system. According to the owner of the www.what3words.com application, their program and algorithm “divide[s] the world into a grid of 3m×3m squares and assign[s] each one a unique 3-word address.” By using this approach, they are able to generate up to fifty-seven (57) trillion unique different 3-word address combinations which denote different parcels of real estate property.

https://support.what3words.com/hc/en-us/articles/203134031-Why-did-you-use-3-words-rather-than-2-words-or-4-words-

A residential or commercial property owner could enter the physical address of the property and the what3word application generates three words that serve to uniquely identify this parcel of real estate. If the physical address for a parcel of real estate is “123 Main Street, Chicago, Ill.” and this property is subject to an easement, then according to the present invention, one could use the what3word application and its algorithm to process this information and generate, for example, the following unique 3-word address: “dog.pencil.number.” This unique 3-word address provides a way to map a parcel of real estate to its physical location on a map. A trademark search of this unique 3-word address could then be performed and, if favorable, then the 3-word address “dog.pencil.number” could be submitted to the state of Illinois along with an application to seek registration of it as a trademark.

Since the property-specific geographic address trademark is primarily directed towards seeking trademark registration at the state level and the physical parcel of land will not be “shipped or distributed” anywhere, then there is no real need to seek or obtain a federal registration.

https://map.what3words.com/
https://en.wikipedia.org/wiki/What3words
See what3word website for more details:
https://support.what3words.com/hc/en-us/sections/201067061-General-concept-platform

According to their website, “All the 3 word addresses are randomly allocated and completely fixed, meaning that they can be used in offline, . . . and [thus] what3words[,] as a universal system[,] . . . never changes.” https://support.what3words.com/hc/en-us/articles/203437482-Can-I-buy-my-own-words-or-change-some-of-the-words-

The what3words.com current policy states that the “core 3 word system will always be free for individuals to use”.

https://support.what3words.com/hc/en-us/articles/203437282-How-much-does-it-cost-) last visited 1/18/2019.

For a property that covers multiple 3×3 m square grids, a user “can decide to use whichever 3 word address appeals to [them] most, for aesthetic or practical reasons.”

https://support.what3words.com/hc/en-us/articles/203437532-My-house-covers-a-number-of-3m-x-3m-grid-squares-Which-3-word-address-do-l-use-

However, the prior art does not disclose, teach, nor anticipate any connection between real property taxes and the creation of an intangible asset, such as an easement, that is placed on a given parcel of land as envisioned by the present invention. Nor does it teach any connection between creating an intangible asset, such as a trademark and associating that trademark with a specific parcel of real estate. This is referred to as a property-specific geographic address trademark and denotes a particular parcel of real estate that, for example, is a property that is subject to a Property Tax Easement Agreement. The owner of the mark can elect to register it with the state where the property is located.

In addition, the prior art does not disclose, teach, nor anticipate using the capital markets as a source for refunding of real property taxes back to an individual or a business by a non-governmental entity, such as a private or public corporation. The present invention does not seek to undermine, impair, weaken, or destroy the existing property tax system. It is envisioned that the existing property tax system will continue to function as usual, with the levying and collecting of property taxes and non-ad valorem taxes by the local governmental tax authority.

The present invention is directed to the aspect of refunding paid real property taxes back to the owners of real estate property. It is also focused on giving tax lien real estate investors and other investors a new asset class and other investment opportunities related to the capital markets.

Under the current existing tax system, the payment of real property taxes is a zero-sum game because individual taxpayers routinely (and usually) do not expect to receive any refund of their property taxes back—once they've been paid to a local tax collector or tax authority.

In order for either a business or an individual human taxpayer to become a winner in the current existing real property tax zero-sum game, they have to either create a “new game related to real property taxes” or be given an opportunity to participate in such a game.

Therefore, one objective of the present invention is to create a process for transforming a zero-sum game (i.e., payment of real property taxes) into a “new (win-win) game related to real property taxes.”

Another objective of the present invention is to give a business and/or an individual taxpayer an opportunity to participate in a new game related to the use of real property taxes to create intangible property assets, such as trademarks and easements.

Another objective of the present invention is to create a new game with established rules that gives the taxpayer distinct known advantages that tend to favor them winning.

Another object of the present invention is to define winning as “a refund of the real property taxes paid by a taxpayer back to them from either a federal, state, or local government entity or from a non-government entity in the form of profits or the form of money such as a check, electronic deposit, bitcoin, currency, cash, etc.”

Another objective of the present invention is to specifically incorporate at least one element from the zero-sum game and linking that element to at least one (or more) real estate properties in the new game contemplated by the invention.

One objective of the present invention is to use at least one element from the zero-sum game and creating at least two new elements, called a “property tax easement” and a “property-specific geographic address trademark,” and a new game that is associated with the real estate parcel that is subject to the property tax easement.

One objective of the present invention is to reposition the relative social relationships and organizational dynamics between property owners and the builders of residential and commercial real estate properties.

One objective of the present invention is to improve upon the current national tax lien sale certificate auction process that involves the sale of delinquent taxes owed on properties to investors.

One objective of the present invention is to provide an alternative source of capital to help individuals and business property owners who are financially affected by post-natural disaster flooding.

One objective of the present invention is to reduce the dependence of individuals and business property owners upon the National Flood Insurance Program which critics argue is outdated or “out of step” with current needs.

One objective of the present invention is to provide an additional source of capital beyond the maximum federal insurance payout that some businesses receive after suffering post-natural disaster flood damage to their business.

One objective of the present invention is to provide an additional source of capital to cover individuals and business owners who suffer flood damage that is not covered by either a federal flood insurance policy or a business-interruption coverage insurance policy.

The present invention integrates the terms “property taxes” (or “real property taxes”) into something more and thus transforms “property taxes” into an important meaningful element that is useful in the present invention.

The present invention integrates the terms “contingent liability” into something more and thus transforms “contingent liability” into an important meaningful element that is useful in the present invention.

The present invention integrates the term “easement” into something more and thus transforms “easement” into an important meaningful element that is useful in the present invention.

The present invention integrates the term “options” into something more and thus transforms “options” into an important meaningful element that is useful in the present invention.

The present invention integrates the terms “refunding of property taxes” (or “refunding of real property taxes”) into something more and thus transforms “refunding of property taxes” into an important meaningful element that is useful in the present invention.

The present invention integrates the terms “using the capital markets as a source for the capital needed to refund the property taxes” into something more and thus transforms “using the capital markets as a source for the capital needed to refund the property taxes” into an important meaningful element that is useful in the present invention.

The present invention integrates the terms “a non-governmental entity providing the refund of the property taxes” into something more and thus transforms “a non-governmental entity providing the refund of the property taxes” into an important meaningful element that is useful in the present invention.

When these terms are combined together according to the teachings, methods, and disclosures of the present invention, then they result in something more and their collective contribution would be anticipated to have an important meaningful impact on a real-world modern capitalist socioeconomic system.

On an individual basis and as taught and disclosed in the present invention, it is believed by the inventor that the property tax easement and the property-specific geographic address trademark element of the invention transforms both the nature, purpose, scope, function, and the use of property taxes in a capitalist socioeconomic market system and a real estate transaction.

On an individual basis and as taught and disclosed in the present invention, it is believed by the inventor that the real property tax option element of the invention transforms both the nature, purpose, scope, function, and the use of property taxes in a capitalist socioeconomic market system and a real estate transaction.

On an individual basis and as taught and disclosed in the present invention, it is believed by the inventor that the real property tax option exchange market element of the invention transforms both the nature, purpose, scope, function, and the use of property taxes in a capitalist socioeconomic market system and a real estate transaction.

On a collective basis and as taught and disclosed in the present invention, it is believed by the inventor that the combination of these different elements, including but not limited to, a property tax easement element, a property-specific geographic address trademark element, a property tax option element, and a property tax option exchange market element, have a transformative effect on the actions of individuals and businesses and affect the nature, purpose, scope, function, and the impact that property taxes can have on a capitalist socioeconomic market system and a real estate transaction.

Another way in which the elements of the present invention contribute to applying the terms in ways resulting in significantly more than the judicial exception itself is by adding a specific limitation related to the word easement.

The present invention teaches that the payment of property taxes is a zero-sum game which can be converted into a win-win game.

On an individual basis, taxpayers seldom or rarely expect to receive a refund of their real property taxes back once they have been paid to a local tax collector or tax authority.

Historically, real property taxes which are a contingent liability—have not been used to create a line item asset category, called a Property Tax Easement that is shown in the financial statements of a company, for the purpose of ensuring that the fundamental accounting equation remains in balance.

Nor have real property taxes been used to create a contingent asset such as a property tax easement for the purpose of it being used as property which can be bought, sold, traded, conveyed, and/or exchanged in an economic transaction.

Nor have real property taxes been used to create an asset such as a property tax easement which, having a fair market value, can serve as an underlying instrument for the purpose of linking it to a new type of option (property tax put or call option) that can be bought, sold, and/or traded on a major publicly-traded exchange, like the Chicago Board of Options Exchange (CBOE) or Euronext—just like any other commodity.

The inventor asserts that the relevant prior art does not teach, use, nor disclose the present invention of a property tax easement as a contingent asset that matches and balances the property tax contingent liability associated with a parcel of land.

The present invention overcomes one or more of the shortcomings of systems and methods related to real property taxes and capital markets. The inventor is unaware of inventions or patents, taken either singly or in combination, which are seen to describe the present invention as claimed.

### SUMMARY OF THE INVENTION

The present invention is directed to a system and a method of using real property taxes to create an intangible asset (such as, but not limited to, a property tax easement), which has a fair market value, that can serve as an underlying instrument or security for the purpose of linking it to a new type of option (property tax put or call option) that can be bought, sold, and/or traded on a major publicly-traded exchange, like the Chicago Board of Options Exchange (CBOE) or Euronext, just like any other commodity.

In another embodiment, the present invention is directed to a system and a method of using real property taxes to create an intangible real estate asset (Property Tax Easement Agreement), which can then be amortized by the easement holder, resulting in a non-cash expense and subsequent reduction in the gross income reported on the tax return of an individual and/or a business by completing certain IRS Forms. This could result in a decreased tax liability and potentially a refund or offsetting of their income taxes and real property taxes owed due to net operating losses that are created and applied as a loss carryback and loss carryforward on the tax returns of an individual and/or a business.

In a further embodiment, the present invention is directed to a system and a method of using real property taxes to create an intangible real estate asset (property-specific geographic address trademark), which can then be amortized by the trademark owner, resulting in a non-cash expense and subsequent reduction in the gross income reported on the tax return of an individual and/or a business by completing certain IRS Forms. This could result in a decreased tax liability and potentially a refund or offsetting of the income taxes and real property taxes owed due to net operating losses that are created and applied as a loss carryback and loss carryforward on the tax returns of an individual and/or a business.

In an additional embodiment, the present invention is directed to a system and method of using real property taxes to create intangible real estate assets (a property tax easement or a property-specific geographic trademark, which can be donated by the respective easement holder and/or trademark owner to an eligible tax-exempt organization). By meeting certain criteria and completing certain IRS Forms, a claim for a deduction of their gross income could result in a decreased tax liability, and potentially a refund or offsetting of the income taxes and property taxes owed due to net operating losses that are created and applied as a loss carryback and loss carryforward on the tax returns of an individual and/or a business.

The present invention includes at least one, several, most or all of the following: a property tax easement, a property-specific geographic address trademark, a Multi-Listing Subscription-type (MLS-type) listing, property tax options, a publicly-traded market exchange, and a Property Tax Refund Program that—collectively, provides the owners of residential real estate property(ies) and/or commercial real estate property(ies) with the means to potentially obtain a real property tax refund each and every year.

### BRIEF DESCRIPTION OF THE DRAWINGS

FIG. 1 shows a fundamental equation of accounting and a relationship between liabilities, assets and value, where liabilities equal assets;

FIG. 2 shows a fundamental equation of accounting and a relationship between contingent liabilities, contingent assets and value, where contingent liabilities equal contingent assets;

FIG. 3 shows a fundamental equation of accounting and a relationship between contingent liability, contingent asset and options according to the present invention, where contingent liability (such as real property tax or taxes owed) equals contingent asset (such as property tax easement);

FIG. 4 is a block diagram of an existing current property tax system;

FIG. 5 is a block diagram of an embodiment of an improvement over an existing current property tax system according to the present invention;

FIG. 6 is a graph of an embodiment of a property tax liability long call option according to the present invention;

FIG. 7 is a block diagram of an embodiment of a property tax system according to the present invention;

FIG. 8 is a graph of an embodiment of a property tax liability long call option according to the present invention, with respect to annual amount owed;

FIG. 9 is a graph of an embodiment of a property tax liability long call option according to the present invention, with respect to tax rate;

FIG. 10 is a graph of an embodiment of a property tax liability long call option according to the present invention, with respect to millage rate; and

FIG. 11 is a graph of a stock long call option contract payoff.

It should be understood that the above-attached figures are not intended to limit the scope of the present invention in any way.

### DETAILED DESCRIPTION OF THE PREFERRED EMBODIMENTS

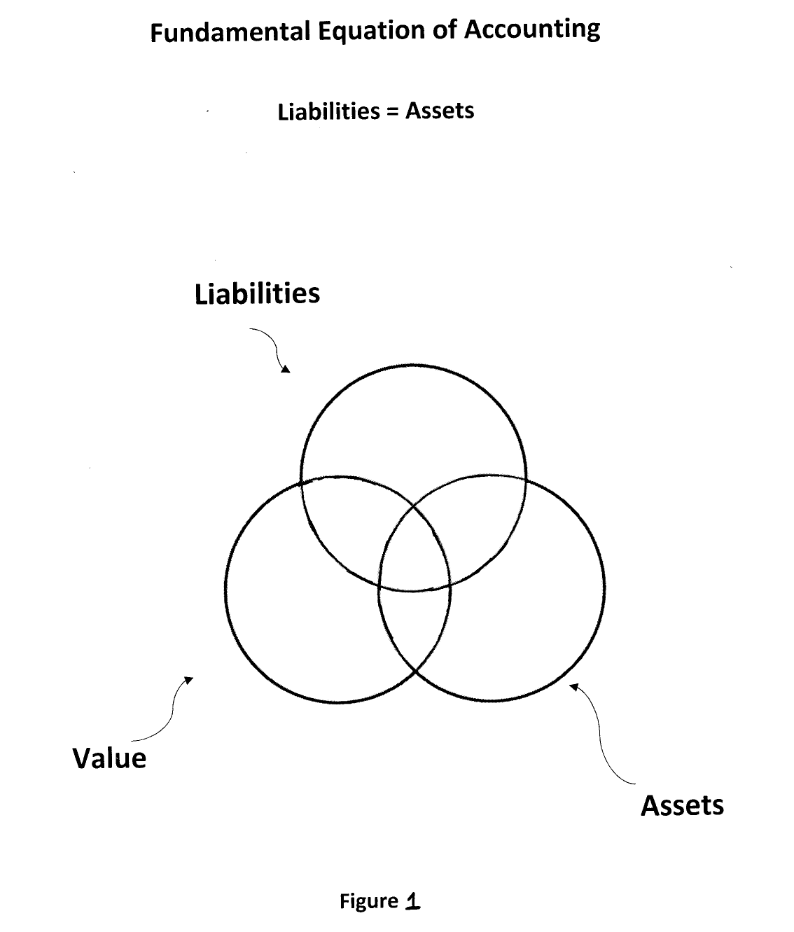

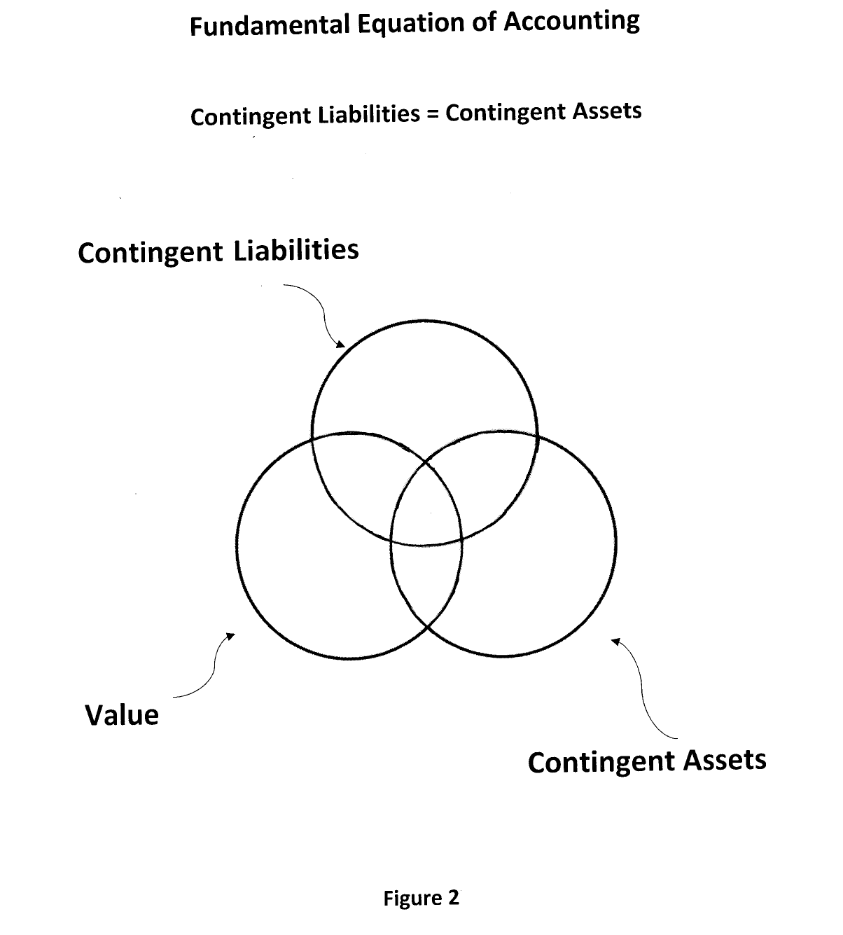

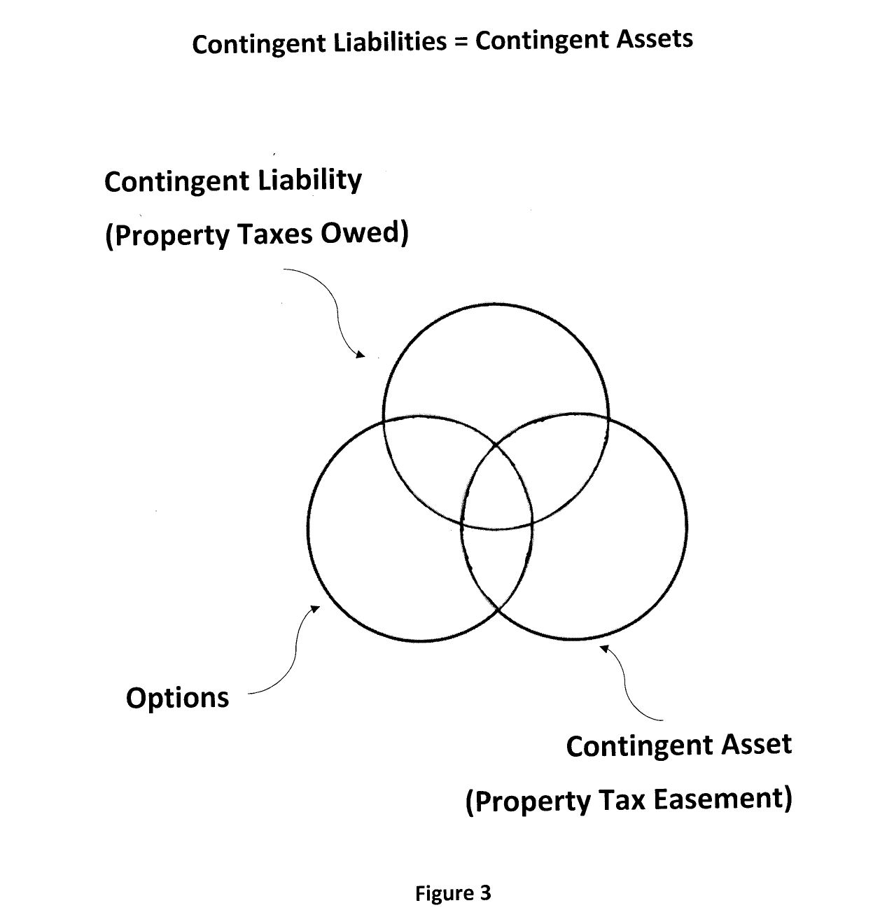

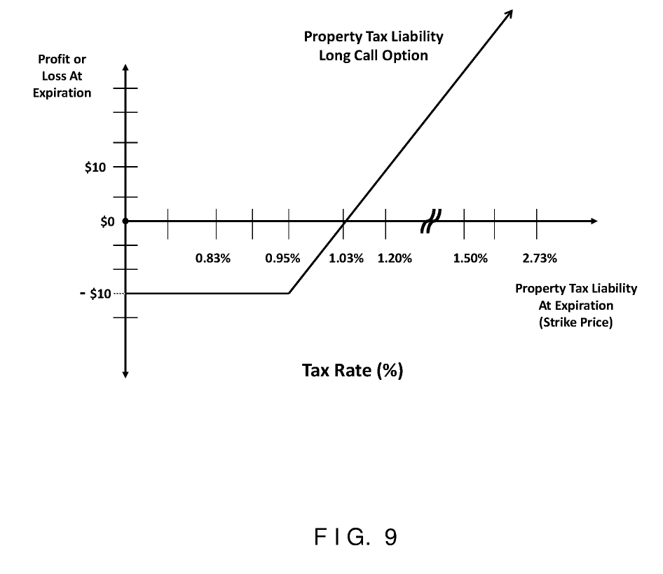

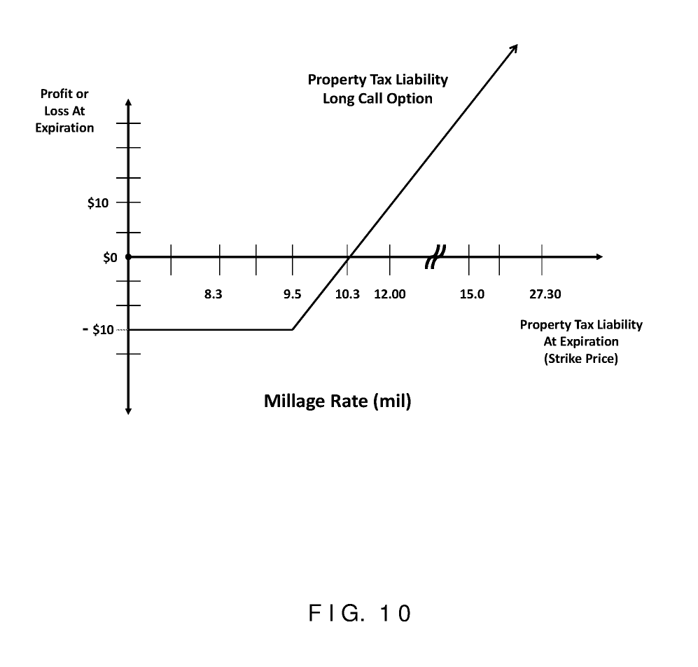

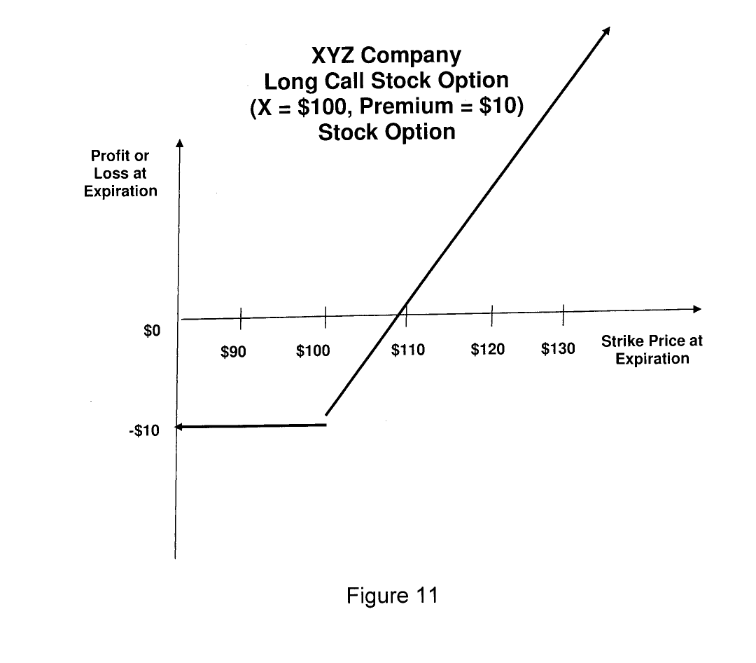

Referring to FIGS. 1-11, the present invention is directed to a system and a method of using real property taxes to create an intangible asset (a “property tax easement”), which has a fair market value, that can serve as an underlying instrument or security for the purpose of linking it to a new type of option (property tax put or call option) that can be bought, sold, and/or traded on, preferably, a major publicly-traded exchange, like the Chicago Board of Options Exchange (CBOE) or Euronext, just like any other commodity. The present invention includes several, most or all of the following: a property tax easement 136, a property-specific geographic address trademark 199, a Multi-Listing Subscription-type (MLS-type) listing, property tax options 138, a publicly-traded market exchange, and a Property Tax Refund Program 130 that—collectively, provides the owners of residential real estate property(ies) and/or commercial real estate property(ies) with the means to potentially obtain a real property tax refund each and every year.

Preferably, with regard to the present invention, the system and method for refunding real property taxes to a property owner comprises (or comprises the steps that include) at least one of the following:

(1) a “Property Tax Easement” 136 and at least one of the additional elements or components:
(2) a “non-government entity,” such as, but not limited to, a private person, a public corporation or a privately-held corporation;
(3) at least one investor who desire to invest in real property taxes by acquiring derivative contracts, such as, but not limited to, puts and call property tax options 138;
(4) a government taxing authority, tax assessor 152, property tax notice, tax collector 154;
(5) property tax options 138 and options market exchange;
(6) a Property Tax Easement Agreement and/or a property-specific geographic address trademark 199;
(7) “fair market value of the Property Tax Easement Agreement;” and/or property-specific geographic address trademark 199;
(8) Local, state, and federal tax forms for personal and business tax returns to claim amortization and charitable contribution deductions of the intangible real estate property assets; and
(9) a residential and/or commercial parcel of real estate property.

As a non-limiting aspect of the present invention, the “property tax easement” 136 and at least one of the additional elements or components are implemented into a portion of a traditional tax administration process or into the entire traditional tax administration process.

As a non-limiting aspect of the present invention, the “non-government entity” facilitates access to the free capital markets by using the property tax easement as an underlying instrument in order to link it to the newly created “property tax option” 138.

As a non-limiting aspect of the present invention, the public corporation or a privately-held corporation facilitates the unique service of rebate (or “refunding”) real property taxes paid by property owners back to them—in lieu of a government entity performing this task.

The present invention discloses a new and useful application of the terms “property taxes” (or “real property taxes”) via a novel approach that is designed to demonstrate how to transform a zero-sum game, typified by the (i.e., the payment of property taxes) into a win-win game.

Easements are well-understood, routine and conventionally used by professionals and those skilled in the art of real estate and real estate law. However, in contrast to the traditional use and understanding of an easement, the present invention introduces a new term of art to the field.

This new term of art that the present invention adds to the field of real estate and real estate law is called a property tax easement 136. Somewhat like other types of easements, a property tax easement 136 is a legal instrument that gives one person certain rights to use something that is related to the property that is subjected to the easement.

The rights granted to the holder of the easement include, but are not limited to, the following:
the right to use the real property taxes for the purpose of monetizing the current tax liability;
the right to use the real property taxes for the purpose of monetizing the future expected real property tax liabilities;
the right to use the value of at least one or more of the real property tax liabilities as the strike price of a property tax call option; and
the right to use the value of at least one or more of the real property tax liabilities as the strike price of a property tax put option.

For the purposes of the present invention, the word phrase “property tax” (or “real property taxes”) is a specific limitation that—when added to well-known, routine, and conventional use and meaning of the word “easement”—literally changes its overall meaning, purpose, and use, from its more widely-understood use and meaning in the field of real estate, title work, tax law, taxation, finance, and real estate law.

Residential and commercial builders in different stages of a real estate project (such as under construction, newly constructed, for sale, pending sales, and/or future planned residential and commercial real estate development projects), existing property owners, and For Sale By Owners (FSBO) would find aspects of the present invention attractive for various reasons. Real estate and non-real estate investors, as well as local county governments would also benefit from the use or application of the present invention.

Both vacant (or non-vacant) land and existing residential and commercial real estate property owners could benefit from the teachings and disclosure of the present invention and its use or application in practice.

The present invention relates to rearranging the temporal relationship of the existing real property tax administration process (i.e., real property tax assessment done, real property tax notice sent, amount of real property taxes owed accepted (or contested) by the real property owner, and real property owner makes payment of property taxes, etc.)—which typically and routinely, does not provide a real property tax refund or rebate on a regular basis, or use the capital markets 190 as the source of any refunds made.

According to the present invention, if the existence of the annual real property tax liability were to be specifically disclosed, listed, and categorized as a separate line item on a corporate balance sheet under the Liability section, then there would have to be a separate, corresponding, identifiable, line item entry of an asset that must be listed under the “Assets” section.

The present invention preferably uses the fundamental equation of accounting that assets must always equal liabilities. In addition, the present invention preferably uses its counterpart equation, requiring that contingent assets must always equal contingent liabilities.

Whether speaking about a business or an individual, there is one main fundamental equation of accounting:

Assets=Liabilities+Shareholder's Equity (Equation #1)

To keep things simple, if shareholder's equity is ignored—then, according to the rules of accounting, every asset has to be offset or balanced by a liability. A liability is defined as a debt that is owed.

In order to take into account the contingent property tax liability, there thus exists a need and a requirement to re-write Equation (1) as:

Contingent Asset=Contingent Liability+Shareholder's Equity (Equation #2)

This contingent asset is distinguishable, is readily identified, and able to be reasonably quantified. In addition, the amount of this asset must offset and have a value that is at least equal to the value of the contingent property tax liability that is anticipated and the expected amount to be owed in order to balance the accounting equation.

Equations #1 and #2 above are both well-known, used, and widely recognized throughout the professional disciplines and the prior art published literature by the professionals who practice in the field of accounting, finance, economics, banking, real estate law, tax law, and taxation.

According to the teaching of the present invention, there exists a high likelihood that the local government tax assessor or collector will continue to make regular assessments of the real estate property taxes owed for a given subject real estate property well into the distant future. This assessment could and would become an obligation of the current property owner and any subsequent owner of the property.

The owner of real property can make the strong assumption that property taxes owed today will also be expected to be owed in the future. The property owner can also make an even stronger assumption that the local government authority or tax collector will continue to exercise it sovereign power and authority to tax the citizens who own real estate property.

According to the teaching of the present invention:

Contingent Liabilities=Property Taxes (Equation #3)

Again, to keep things simple and ignoring Shareholder's equity, the accounting equation can now be re-written as follows:

Contingent Asset=Contingent Liability(Property Tax) (Equation #4)

However, given the Equations #3 and #4 above, there are two main questions that must be raised (and that are answered) by the present invention.

1) Does there exist a “Contingent Asset” which will offset and balance the Contingent Liability (real property tax)?

2) If so, then what is the name of this Contingent Asset?

Upon information and belief, the inventor believes that neither the published prior art, the published literature, or the professionals who practice in the field of accounting, finance, economics, banking, real estate law, tax law, and taxation teach, disclose, or provide an answer to these two questions related to and raised by Equations #3 and #4.

As such, the present invention recognizes this knowledge gap in the prior art and thus provides an answer to this real world problem.

Instead of thinking about real property taxes as a liability (or at best, a contingent liability), the present invention view property taxes from the perspective of its contingent asset. But what type of asset?

Since every asset item on a balance sheet has to be classified as either a “tangible asset” or an “intangible “asset” and each item must be something that is readily identifiable, quantifiable, and at least equal in value to its counterpart—which is a liability, then the most plausible way to answer the question was to consider an intangible asset.

According to the present invention, a property tax easement 136 is an intangible asset and thus it should be useful for the purpose of serving as the underlying for an option contract.

According to the Dictionary of Real Estate Appraisal and as commonly understood in the field of real estate law, an easement is defined as the “conveyance of certain property rights, but not ownership, to a parcel of real estate.”

Another source defines the word easement as “an interest in real property that conveys use, but not ownership, of a portion of an owner's property. Access or right of way easements may be acquired by private parties or public utilities.

Governments dedicate conservation, open space, and preservation easements.”—the Dictionary of Real Estate Appraisal—4th Edition.

These property rights define the rights of ownership related to the property—as if the rights were a “bundle of sticks.” This bundle of rights includes, the right to sell, convey, transfer, use, to enter upon it, to lease it, to give it away, the right to refuse to do any of these things, etc. As such, a property owner could choose to keep all the sticks in the bundle together or wholly intact and maintain a fee simple estate. Or, the property owner could elect to convey certain rights to a third party—meaning that the other party would have the legal right to exercise those rights granted to them by the property owner.

Easements can be categorized according to their length of time and can be granted for an indefinite or permanent period of time. Or, an easement may be granted for a known, finite, or fixed period of time by the grantor such as for 12 months, 12 years, or 300 years.

In addition to a length of time associated with an easement, it is also well known that an easement can be categorized according to the space that it affects. There are different types of easements, such as subsurface, surface, and overhead easements that may provide the right to dig water and sewer lines, erect billboard signage, or fly over certain property. Real estate appraisers face the task of determining if and how an easement affects the use or utility of a property, and how it affects the actual market sale of a property (before and after) placement of the easement. By comparing its value to other final sold properties that are unencumbered with an easement, appraisers can calculate a fair market value for the easement.

For example, an easement is unique to one property. It is distinguishable from other easements on the same property and specifically grants a partial taking or defined interest (estate) in the subject property to another person—other than the owner of the underlying fee simple interest. As such, an easement is generally understood to mean “an estate or interest in land.” The specific property rights granted to the other person are delineated in the easement document and typically refers to a “servient estate” and a “dominant estate.”

However, in the present invention, the term “property tax easement” 136 represents an estate or interest, not specifically in the land itself but, rather, in the property taxes that the land is subject to pursuant to the sovereign power and authority of the local government. The property tax easement 136 is granted by the property owner to another person in exchange for certain mutual benefits that each party enjoys. The owner of the property still has and retains physical possession of the property. The property owner also has the legal duty, obligation, and responsibility to pay all of the property taxes on the property as they become owed and due. The easement holder has no legal duty, obligation, or responsibility to pay the property taxes. Nor does the easement holder have the right to physically take or possess the property subject to the easement. The easement is different from a lien in that a lien gives the lien holder the right to foreclose on the property, possess, and sell the property.

According to the present invention, one of the intended purposes of the property tax easement 136 is to give the general public or a party (such as, but not limited to, a buyer, a seller, or an investor) both notice and information that the easement exists.

According to the present invention, one of the intended purposes of the property tax easement 136 is to give the easement holder (and/or his agent) the legal right, authority, and permission to enter over, under, across, through, and within the property via vehicle (manned and unmanned) or by foot for the purpose of evaluating it and the property taxes that may be owed on the property now or in the future.

According to the present invention, one of the intended purposes of the property tax easement 136 is to identify certain real estate property and evaluate and determine its suitability for enrollment and retention in a Property Tax Refund Program 130.

According to the present invention, another intended purpose and use of the property tax easement 136 and property tax option 138 is to give the general public or a party (such as, but not limited to, a buyer, a seller, or an investor) both notice and information that a given residential or commercial real estate property is enrolled in the Property Tax Refund Program 130.

According to the present invention, another intended purpose and use of the property tax easement 136 and property tax option 138 is to facilitate the acquisition of residential and commercial real estate property during contract negotiations.

With the increasing use of mobile devices, smart tablets, and cellphones used to view real estate property, there may often be a limitation on the amount of data, memory, and information that can be obtained and displayed about a subject property. Many printed and electronic MLS listings have multiple images of a subject property which highlight certain interior and exterior features, bedrooms. bathrooms, kitchen, etc. Recent property tax data related to a subject property may also be given and displayed on the same webpage or printed page for the property. However, any additional property tax information that may be needed requires a person to go in person or log onto a different website such as a government entity, a property tax collector, property tax assessor, or entity having tax jurisdiction authority, before they can obtain any older property tax data—because often, the number of years displayed may only be the last three years' worth of property data.

According to the present invention, the system 100 of the present invention includes a database and/or printed directory, preferably a proprietary online MLS-type database and/or printed directory 131, consisting exclusively or primarily of residential or commercial real estate property that has been preferably granted a license to use the mark PROPERTY TAX EASEMENT™. This database and/or directory 131 would serve as a primary resource for any real estate brokers, realtors, real estate agents, investors, and the general public who desire to quickly and easily identify commercial and residential properties available for purchase, sale, and/or trade. This type of database and/or directory 131 would cover different local and regional geographic locations and contain a wealth of information about each property such as the current property taxes, address, listing price, etc. These properties would be recognized as enrolled into and participating in the Property Tax Refund Program 130 and thus offer a competitive advantage over other similar competing online MLS directories and printed real estate property listings.

The proprietary online MLS-type database and/or printed directory 131 of the present invention preferably includes information such as the annual amount of property taxes owed (or paid) for a given real estate property or parcel of land listed for sale, the physical address of the property, the name of the property owner, a tax ID, and a legal description that identifies the listed property being taxed by the taxing authority.

As a non-limiting example, the property tax easement database 137 of the present invention has similarity to the form and function of a generic typical multiple-listing service (MLS) that is widely known and used by professionals in the real estate industry. Preferably, the property tax easement database 137 includes the capability of collecting, storing, retrieving, computing, and displaying the historical average and standard deviation of the property taxes paid related to a real estate property, wherein the calculated information would provide a benefit to a plurality of investors and property owners. As a non-limiting example, the database 137 includes a calculation-performing device or a calculation-performing capability that performs and/or provides calculation that reflects the average (mean) value and standard deviation of property taxes which have been paid over a period of time—for example, seven years, related to a given subject property. Although some currently-used print and electronic MLS directory listings may provide and display a sample of the most recent one or two years of property taxes paid and property taxes assessed—this information is usually for a specific year only. In contrast, the present invention seeks to improve upon the prior art by providing one who practices the invention with new, additional, useful, information about the average amount and standard deviation of property taxes related to a subject property paid during a certain desired period of time, for example—the immediate past seven years. Those who have and use this information would realize a real world benefit because they would then be able to easily and efficiently construct a probability distribution and this would aid them in their decision-making process as to whether, for example—an investor should or should not invest in a certain real estate property. This probability distribution and information can then be compared with other different real estate properties in the same category (i.e., single family home, retail shopping center, office building, etc.), in the same price range, the same or a different city, etc.

As a non-limiting example, the printed and electronic MLS listings of properties may provide similar data in a tabular format. For example, the past fifteen years of property taxes may be listed in two columns of data, side-by-side, where each respective column is labeled “Year” and “Amount of Tax Liability.” Currently in the art, a person would have to copy the amount for each year and to perform a mental calculation or using a calculator to calculate the mean and standard deviation.

As a non-limiting example, assume that an investment banker is asked to make a determination about the valuation of a private company that owns substantial real estate assets—in addition to its business operations. A business may be sold or combined and merged with another business through a merger and acquisition (M&A) process and its price determined based upon, for example, an enterprise value (EV) which is related to some multiple of EBITDA. The inventor understands that if this private company is a lower middle market business that is being sold—then, many times, the real estate holdings are sold or leased separately from the business itself. During the due diligence phase of the M&A process when the purchase price allocation section of the merger model is set up, the inventor understands that many M&A professionals currently do not consider the valuation of real estate intangible assets, related to property taxes as part of their purchase price allocation calculations for either the buyer or the seller. If there are one or two properties, then this process may not take a long time. However, for some large corporations which may have up to hundreds or thousands of different locations and each site could have multi-year property data in a similar columnar format, then this would not be economical, practical, feasible, or cost-effective. The banker may be challenged to come up with a meaningful value for the entire business. As such, the investment banker may hire a valuation specialist or an appraiser to assist with the valuation. The hired person may choose to use “a replacement cost approach” (based on the principle of substitution), the income capitalization approach, or a sales comparison approach to determine the value of the business owned real estate holdings. However, all three of these approaches do not necessarily work for valuation of intangible real estate property, such as easements, mineral or water rights, air rights, etc. Thus, the proprietary online MLS-type database and/or printed directory 131 of the present invention can be very useful.

As a non-limiting example, the property tax easement database 137 includes computer hardware (or a computer hardware system) and computer software wherein computer software is implemented using computer hardware, ROM, RAM, computer data files in a computer-readable format, graphical user input, graphical user output, the Internet, and, possibly, a network of computers, in order to retrieve, process, handle, and manipulate property tax data from a plurality of databases. The software would then perform a series of distinct processes to automate a task that goes beyond simply organizing the retrieved information and presenting it in a new form or carrying out a fundamental existing economic process. In contrast to the similar task which is currently being performed by humans such as appraisers and can be laborious in nature, and may require review and inspection of comparable and comparison properties, and then, due to time constraints, may only include a limited sample of the entire hundreds or thousands of different real estate locations, the present invention solves this real world problem by providing the historical data in a format—whose calculated average value+/−standard deviation value can then be incorporated into a probability distribution and used by the user in their decision-making process.

The expected results and benefit to the user include, having increased flexibility, faster search and retrieval times, and smaller memory requirements needed to understand the data, perform analysis of the data, and gain insight about the valuation of the business real estate holdings. One specific application of the probability distribution function involves linking the computed mean value to the strike price of an option and the standard deviations can then be used to determine the range of prices above and below the strike price.

In addition, in contrast to using a computer software, computer hardware, and mathematical algorithm(s) simply as a tool for automating the process of calculating the mean and standard deviation of the real property taxes paid on a subject property during the past several years, the system and method of the present invention also improves the functioning of a computer-related technology as follows: for example, once the probability distribution is calculated say for a dataset of one hundred single family homes located in Chicago during the past seven years, then this information could be compared to other dataset of one hundred single family homes located in other cities. It could be compared to a dataset of one hundred hotels, or a dataset of one hundred apartments, or one hundred retail shopping centers all located in Chicago and other cities, such as New York City or Miami. This results in a new type of self-referential database and thus is a new and useful improvement upon the standard information typically found in a printed or electronic MLS-type listing of real estate property.

Preferably, the computer hardware (or computer hardware system) of the present invention may be any computer hardware (or computer hardware system) known to one of ordinary skill in the art that allows the application of the embodiments of the present invention to be implemented.

According to the present invention, a proprietary website portal would preferably be created to give property owners the ability to pay their property owed on the property directly to the local tax collector, if desired.

Preferably, the Property Tax Easement Agreement is visible and displayable in print and on an electronic MLS directory listing 131 and conveys additional useful material information about a residential or commercial real estate property.

Preferably, the “fair market value of the property tax easement” provides a user with useful financial information associated with the residential or commercial real estate property, such as the fair market value of the subject property itself before and after placing the property tax easement 136 on the property. Just as conservation easements are known to have value, then it is believed that a property tax easement 136 (legal document) and the rights associated with it will also have value. It is believed that the value associated with the “fair market value of the property tax easement” would and should be separate and distinct from the value which the “property tax easement” 136 itself would be independently valued at by an appraiser.

Source: https://www.forbes.com/sites/peterjreilly/2016/01/1.4/conservation-easement-tax-deductions-and-valuation-abuse/#7f49f2865f63

Preferably, the “contingent value of the property tax easement” provides a user with useful financial information associated with the residential or commercial real estate property, such as the value of the property tax easement 136 as determined by the contingent liability that is created upon the issuance of a property tax notice 156 to a property owner that is owed and payable by a date certain. It is believed that this element may be correlated with and/or related to the fair market value of the subject property itself before and after placing the property tax easement 136 on the property. It is believed that the value associated with the “fair market value of the property tax easement” would and should be separate, distinct, and independently valued by an appraiser.

Property Tax Options

The present invention discloses a security instrument created based upon the ad valorem or real property taxes which each tax collector 154/assessor 152 of a municipality, city, county, or state sends out to its respective real estate property owners and business owners on a regular basis.

In the present invention, the property tax easement 136 serves as the underlying intangible asset that is associated with a specific real estate property. Since the underlying intangible asset has a value and this value can be linked to the property tax easement 136 (as measured by the difference in the market value of a subject property before and after an easement is placed on the property) and/or as determined by the real property tax liability, then, the amount of the annual real property taxes owed can serve as the strike price for an option. There are multiple different properties that have different annual real property taxes owed based on their respective assessed value. This means multiple strike prices can be offered for the property tax options 138 that are bought, sold, and/or traded on a public market exchange.

Property is assessed by a tax assessor 152 on, for example, an annual basis and typically a real property tax notice 156 (liability) is issued by a local government entity to the property owner. Thus, there is a direct connection and nexus between a property tax easement 136 placed on a specific real estate property and the real property taxes that attach to this property as a liability that its owner must pay to a local government entity.

A real estate investor 140 can buy an option(s) and use leverage to take advantage of the “price” movement that occurs as a result of the annual property tax assessment, property appreciation, property depreciation, and property tax liability associated with a specific real estate property.

However, in contrast to the price of a share of stock fluctuating, according to the present invention, it is the fluctuation in the real property taxes routinely assessed and owed that an investor should seek to exploit for profits.

It is known that if the price of a stock increases by a certain percentage this usually generates a larger percent change in the price of an option.

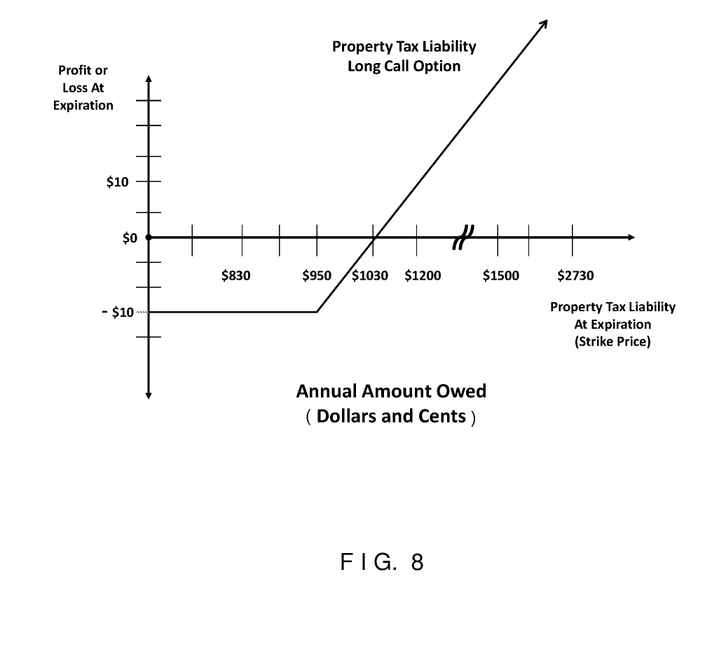

Likewise, if the price, specifically the amount of real property taxes (annual amount owed in dollars and cents, tax rate, or the millage rate) owed for a property increases by a certain amount—as shown in FIGS. 8-10, then this would be expected to generate a larger percent change in the price of a real property tax option 138.

One embodiment of the present invention is a security instrument that is a call option linked to the ad valorem or real property taxes. Since many property and business owners have often experienced an increase in their annual real property taxes owed, then one way that they could mitigate against this risk is by buying and/or selling “property tax call options.”

Alternatively, since many residential and commercial business property owners may suffer significant financial loss due to flooding after a natural disaster, then one way to mitigate against this financial risk is buying and/or selling “property tax put options.”

These property tax call and put options could be created, underwritten, issued, bought, sold, and distributed on one of the existing national, regional, or international options exchange markets.

By using a property tax easement 136 (which is an intangible, contingent asset) as the underlying security and using the amount of the annual property taxes assessed and owed on a given subject property as the strike price for a property tax option 138, a property owner (residential and/or commercial) as well as other interested investors, can buy, sell, and/or trade property tax futures and options contracts on a public exchange. A property tax easement 136 and property tax options 138 may be used as a means by which the owners of either residential and/or commercial real estate property can potentially obtain a real property tax refund each and every year. Given the fact that the real property taxes owed on vacant (or non-vacant) land have an (almost guaranteed) tendency to increase once improvements have been made to the land—and, given the additional fact and strong tendency for property taxes to again increase within 1-2 years after a new property-owner occupies the property, then a property owner, builder, and/or investor can use these two facts and different futures and option strategies, such as a naked call option to take positions that advantageously gives them an opportunity to consistently win profits and obtain a property tax refund year after year. Ultimately, a property owner can transform this zero-sum game into a “win-win” game. However, there are some tax authorities where the property taxes decrease after capital improvements have been made to a vacant (or non-vacant) lot, such as in Washington, D.C.

The Table of Steps of the present invention below illustrates how the present invention would be used to create a property tax long call option related to a vacant (or non-vacant) lot owned by, for example, a builder or property owner.

As a non-limiting example of a method to create a property tax long call (and/or put) option related to a vacant (or non-vacant) lot owned by, for example, a builder and/or a property owner or where the builder has legal rights to the vacant (or non-vacant) lot, the method to create a property tax long call (and/or put) option comprises the steps of:
(1) providing to a real property owner and/or builder of a vacant (or non-vacant) lot with an opportunity to join the Property Tax Refund Program 130;
(2) real property owner and/or builder granting a property tax easement 136 on the vacant (or non-vacant) lot for the purpose of creating a property tax option 138;
(3) linking the property tax easement 136 to the property tax option 138 with strike price equal to the annual real property taxes expected to be owed;
(4) real property owner and/or builder making capital improvement (such as, but not limited to, building a house) on the vacant (or non-vacant) lot;
(5) real property owner and/or builder buying a long naked call (and/or put) option contract;
(6) real property owner and/or builder receiving a real property tax notice or bill 156 showing an increased amount of real property taxes owed for next year resultant from the completed capital improvements and higher taxable assessed property value;
(7) real property owner and/or builder paying the real property tax bill to a tax collector 154 for the higher real property taxes owed; and
(8) exercising property tax call (and/or put) option prior to its expiration date and splitting profits among real property owner and/or builder.

As a non-limiting example, a buyer of an option has the right to buy (a call option) or to sell (put option) an underlying asset at a fixed price (strike price or exercise price) for a given period of time before the option expires. The buyer of the call option wants the price of the underlying asset to go up. The seller of the call option wants the price of the underlying asset to go down. If the price of the underlying asset goes above the option's strike price, the option holder will purchase the asset at the strike price and then sell it at the higher market price, making a profit. The option writer must sell the asset at the strike price (which is lower than the asset's market price). If the seller does not already own the underlying asset, then the seller will have to purchase it at the higher market price. The option seller receives the option premium upfront from the buyer of an option. The option seller is obligated to sell (in the case of a call option) or to buy (in the case of a put option) an underlying asset according to the terms of the option contract. If exercising the option would be unprofitable for the option buyer, then they have the right to walk away from the transaction. However, an option seller cannot walk away from their contractual obligation.

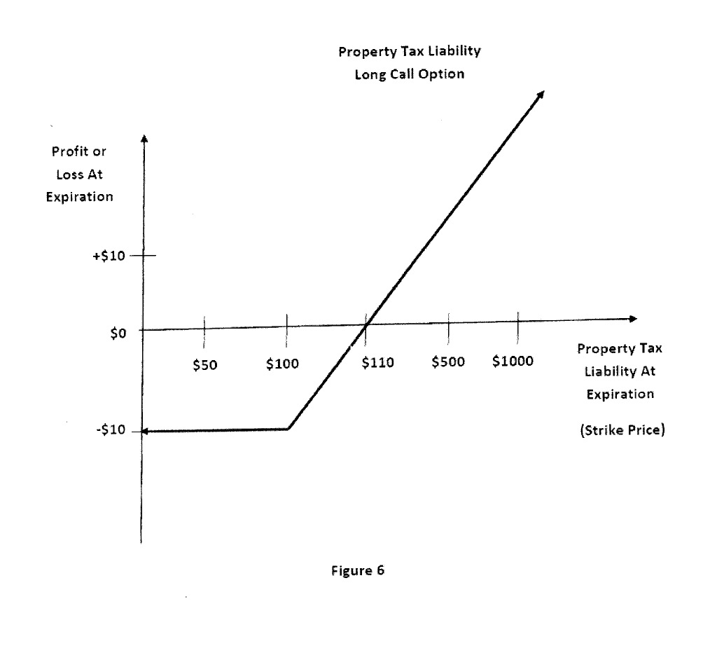

FIG. 6 illustrates how the invention would be used to create a property tax long call option related to a vacant (or non-vacant) lot owned, for example, by a builder and/or property owner.

A property tax liability option is a contract between a buyer and a seller.

In one embodiment of the present invention, a “property tax liability” option serves as the equivalent of a “stock” option.

However, instead of buying 100 shares of the underlying stock, a property tax liability option contract gives the buyer of the contract the right to buy (or sell) 100 units of the underlying property tax liability associated with at least one subject property at a predetermined price on or before the expiration date. For example, the buyer of a property tax liability option contract, such as a real estate investor, obtains the right to buy (or sell) 100 contracts associated with vacant (and/or non-vacant) lots on which a house will be built within the next 24 months and the property taxes are expected to increase or decrease once the improvements have been completed.

Alternatively, according to the present invention, one property tax liability unit is equal to $1.00 (USD) of property taxes owed by at least one property owner. If the annual real property taxes owed for a parcel is $1000 (USD), then this represents 1000 units.

The buyer of the real property tax liability option is not obligated to buy (or sell) the underlying real property tax liability.

Any action that the buyer may take to buy (or sell) the underlying real property tax liability would typically be done if it is profitable for them.

The attributes of the real property tax liability option are identifiable and similar to a stock option:
the price of the option which is called the premium. This represents what the buyer of the property tax liability option would have to pay to the seller of the option;
the predetermined price of the underlying real property tax liability is known as the strike price (or the exercise price);
the property tax liability price (or the market price) represents the amount of the real property tax liability; and
there is also an expiration date.

If an investor expects the real property tax liability to be higher in the future, then they would buy a property tax liability call option and pay the seller of the option a premium—for example, $10.00 per option contract.

If the real property taxes owed on parcel A was equal to $100 (USD) last year, then $100 would represent the strike price. The break-even price for the investor would be $100+$10.00 or $110 per option contract.

If the real property tax liability next year is greater than $110, then the investor who holds the call option would exercise their contract and take a profit. Thus, if the real property tax liability is $152, then this would represent a gross profit of $42 per contract for the investor.

On a traditional publicly-traded or private exchange, there are option chains which represent a range of different strike prices that are available. The difference between each strike price is standardized (i.e., $1, $2, $5, $10, etc.) and often based on the price of the stock.

In the present invention, there are option chains which represent a range of different real property tax liabilities (strike prices) owed by different real property owners. The option chains could be established to represent a range of different real property tax liabilities (strike prices) that are available based upon different individual real estate properties owned by one or more property owners.

In another embodiment, instead of buying 100 shares of the underlying stock, a property tax liability option contract could give the buyer of the option the right to buy or sell the property tax liability associated with 100 parcels of already existing real estate that will undergo capital improvements within the next 24 months.

Thus, if there are 100 parcels of property in the same (or different) state, county, city, or municipality and each had real property taxes owed last year in the amount of $100 (USD), then these 100 subject properties could collectively be treated and considered equivalent to the 100 shares of an underlying stock.

If the annual real property taxes on each of these 100 parcels increased over the next year, then the buyer of the call option could exercise the option, and sell the underlying real property tax liabilities at the market price and make a profit.

As a non-limiting example, another embodiment of the method of the present invention is:
(1) a real property owner and/or a builder (which are non-limiting examples of a party associated with a real property lot) creating an account and acquiring property tax call and/or put options related to real estate property;
(2) real property owner and/or builder deciding how much simple interest they are willing to pay an investor;
(3) real property owner and/or builder calculating their average annual real property tax bill from the past certain number of years (such as seven years);
(4) real property owner and/or builder funding their account by placing certain number of years (such as two years) worth of real property taxes into an account in addition to a certain amount of simple annual interest (for example 10%);
(5) investor(s) looking for a good investment that pays a certain (such as 10%) simple annual interest;
(6) investor(s) contributing a certain number of years (such as one year) worth of real property taxes owed to the property owner's or and/or builder's account;
(7) real property owner and/or builder receiving higher real property tax notice from local tax collector due to market appreciation and/or capital improvements;
(8) real property owner and/or builder paying their real property tax bill to tax collector for the real property taxes owed;
(9) providing proof of property taxes paid provided from the tax collector office to the investor;
(10) exercising property tax option and splitting profits between (a) real property owner and/or builder and (b) investor;
(11) investor receiving their annual simple interest and their principle back from the real property owner; and
(12) real property owner and/or builder receiving a refund of their paid real property taxes from the investor's account and/or the capital markets 190.

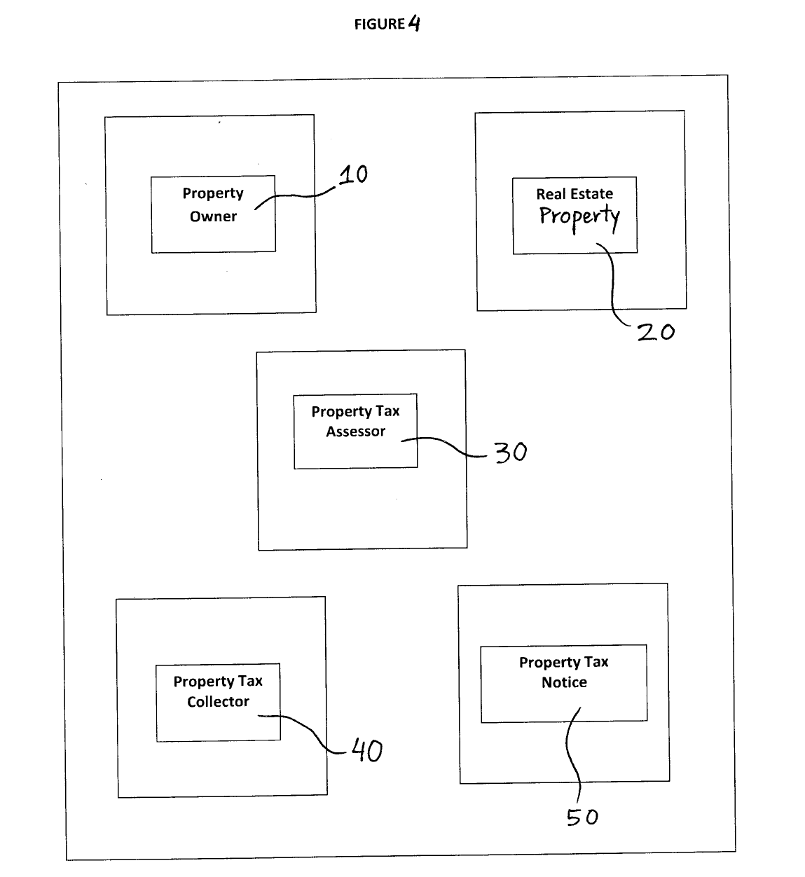

FIG. 4, broadly speaking, may represent a current real property tax system. In many taxing jurisdictions, there is a real property owner 10 who is the owner of a real estate property 20, which may be, for example, a vacant (or non-vacant) lot. The real property tax assessor 30 performs an assessment of the real estate property 20 and this may be on an annual basis—or perhaps every 3, 5 or 10 years or whatever periodic schedule that the local government may require. The owner 10 of the real estate property 20 pays the amount that is owed to the real property tax collector 40 in response to having received a real property tax notice 50, which created a legal debt obligation and real property tax liability. This process repeats itself on a regular basis.

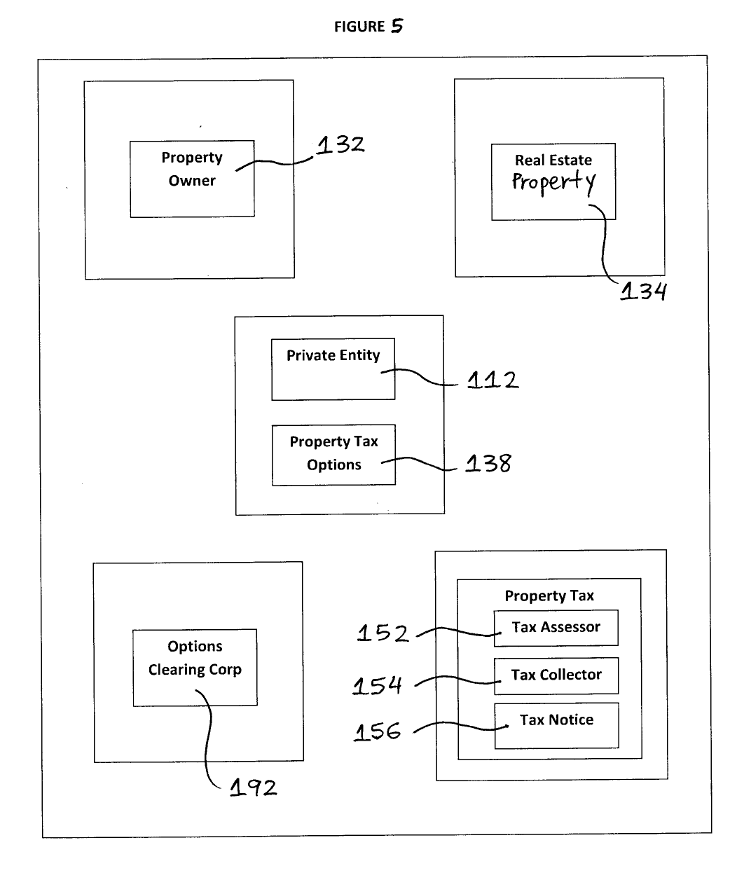

In accordance with an embodiment of the present invention, FIG. 5, broadly speaking, represents an improvement over the existing current real property tax system. There is a real property owner 132 who is the owner of a real estate property 134, which may be, for example, a vacant (or non-vacant) lot. The real property owner 132 may build a new house or commercial building on the property 134. The real property tax process, consisting of a real property tax assessor 152 performs an assessment of the real estate property 134 and this may be on an annual basis or every 3, 5 or 10 years—or whatever periodic schedule that the local government may require. Since the vacant (or non-vacant) lot has now been improved and a new house or commercial building exists, then the taxable assessed value of the property 134 will typically be higher (but, in some tax jurisdictions, it may be lower) than its previous assessment as a vacant (or non-vacant) lot.

The owner 132 of the real estate property 134 now owes and must pay a higher (or lower) amount of real property taxes to the real property tax collector 154—resulting from a higher taxable assessed value of their property 134 as determined by the property tax assessor 152 in response to having received a real property tax notice 156 which created a legal debt obligation and real property tax liability.

In accordance with this embodiment of the present invention, at least three new elements (labeled 112, 138, and 192) are now introduced into the current real property tax system comprising 152, 154, 156. These three elements are a private entity 112 which may be a private or publicly-held corporation, trust, entity, or person. This private entity 112 may issue and buy, sell, trade, or exchange property tax options 138 itself or through a third party such as a broker dealer that are then publicly traded on a market exchange. The types of property tax options 138 may be a put option or a call option. The options that are bought, sold, traded, and exchanged will typically be settled by another company, such as an options clearing corporation 192 as is commonly well known in the industry. This process involving the buying and selling of property tax options 138 could repeat itself on a regular basis depending on the needs of those who practice the present invention.

As a non-limiting example of an application of the present invention, consider a family of four consisting of a husband, wife, and two children who just graduated with their college degrees. Both parents worked two jobs, incurred $250K in total debt, and the entire family has a total of $50K in the bank and live in a home owned free and clear and worth $50K. The family pays $1K a year in annual property taxes. Altogether, the entire family has a total wealth of $50K+$50K=$100K. The husband and wife wish to create a legacy for their grandchildren, great-grandchildren and great-great grandchildren. They wish to practice the invention as a way to address multi-generational poverty and massive consumer debt. They recognize the fact that only two things in life are certain—death and taxes. They realize that if they follow the steps disclosed in the present invention, then they could have an opportunity to effect a transformation of their present socioeconomic state (i.e., $100K total wealth) to a different and better state ($500K). In addition, if they follow the steps disclosed in the present invention, then they could have an opportunity to realize an overall reduction of a particular item (i.e., $250K debt) down to a much lower state of indebtedness ($10K) because they could use the profits generated from exercising their property tax options 138 to pay off their family debts.

As another non-limiting example of an application of the present invention, consider a new home buyer, a residential homebuilder, a commercial builder, or a property developer. Upon buying a vacant (or non-vacant) parcel of land, the builder or property developer could purchase naked call options for each lot that they own, plan to build upon, and intend to sell. The naked call options would have staggered expiration dates throughout the year to allow for any potential delays in completing the building project. After each project has been completed, a new real property tax assessment must be done which typically will result in the improved property having to be assessed at a higher valuation. As such, the property taxes on each of the builder's lot will be expected to invariably increase. After the real property taxes have increased, the builder or property developer then simply exercises his naked call options, exits the position, and takes his profits directly from the free capital markets 190.

As a further non-limiting example of an application of the present invention, consider the President of a country, the head of a foreign state, or the ruler of a nation-state. For example, if a foreign nation-state wanted to transform its current economic system from one state (such as communism or socialism) into a different state (such as capitalism), then the present invention could be implemented by the government of that country as a way of dealing with its national debts.

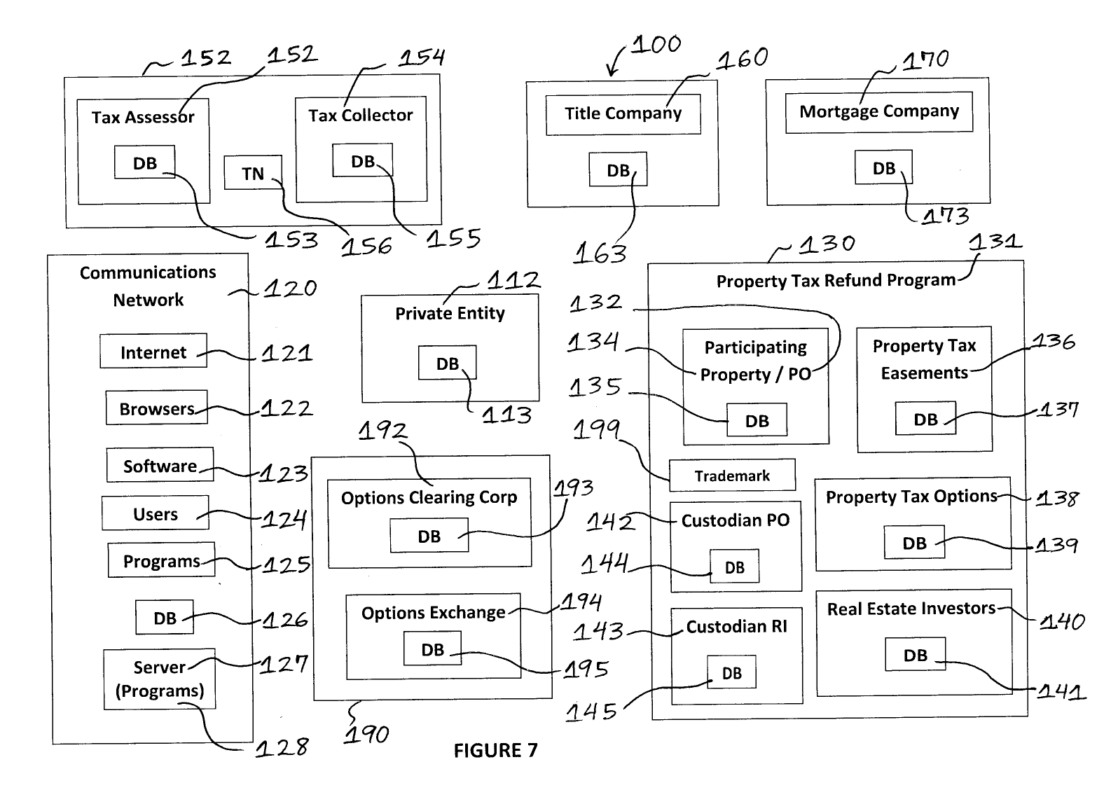

FIG. 7 is a general overview of the present invention and includes a private entity 112 with a database 113 and using a communications network 120 as a means of organizing, managing, implementing, and operating a Property Tax Refund program 130 so that the actions of other third-parties such as a state or local taxing authority 150, the capital markets 190, a title company 160, and a mortgage company 170 can be most efficiently and effectively utilized to achieve the objectives of the present invention.

Different elements of the communications network 120 include the Internet 121, at least one (or more) browser 122, software 123, authorized users 124, software programs 125, a database 126, along with at least one (or more) server 127, and server software programs 128.

Different elements of the Property Tax Refund Program 130 will be explained shortly.

Different elements of the taxing authority 150 include a tax assessor 152 and a tax collector 154 (such as, but not limited to, a tax collector office) and their respective tax assessor database 153 and tax collector database 155. A Tax Notice (TN) 156 related to a given subject property is also an element that the tax assessor 152 would typically send to a property owner 132, who would be expected to make any property tax payments owed to the tax collector 154.

Different elements of the capital markets 190 include an options clearing corporation 192 and at least one (or more) options exchange 194 and their respective options clearing corporation database 193 and options exchange database 195.

At least one (or more) title company 160 and mortgage company 170 and their respective title company database 163 and mortgage company database 173, are additional elements of the present invention which are useful in helping to determine if certain real estate property is free and clear or if it is encumbered by a mortgage, any restrictive covenants, or any non-property tax easements.

As envisioned, a private entity 112 creates a proprietary MLS-like database directory 131 which is linked to the Property Tax Refund Program 130 and consists of at least one or more property owners 132 and their participating properties 134, that collectively constitutes a database 135. The database 135 also includes those properties that have a property-specific geographic address trademark 199 associated with the property. Examples of different types of participating properties 134 include, but are not limited to, vacant (or non-vacant) land, single family homes, commercial office buildings, multi-family residential apartments, condominiums, theme parks, hotels, and real estate used for industrial and manufacturing purposes. Ownership of each participating property 134 is determined by at least one (or more) title company 160 that conducts a title search of the subject property based upon the legal description of the participating property 134 as part of a vetting process. Upon meeting certain criteria, approval, and passing the vetting process, the property becomes subject to a property tax easement 136.

The property tax easement 136 is entered into between the grantor (property owner 132) whereby certain rights are granted by the grantor to the grantee (private entity 112 and recipient of property tax easement 136). The property tax easement 136 may be for a finite or an indefinite period of time and have other relevant and material terms and conditions which affect the subject property. Other properties that have undergone a similar process and been granted a property tax easement 136 collectively constitute a property tax easement database 137.

At least one (or more) third-party custodial property 142 owner companies is used to establish, create, and maintain an account for the property owner 132 in a property owner database 144. A similar third-party custodial real estate investor company 143 is used to establish, create, and maintain an account for real estate investors in a real estate investor database 145 designed for investment purposes.

Certain types of properties in the property tax easement database 137, such as vacant (or non-vacant) land, may be linked to a property tax options 138 and serve as an underlying instrument for a property tax call options contract. It is envisioned that different types of option contracts, such as put and call options, would collectively constitute a property tax options database 139.

Real property owners 132 may consist, for example, of residential builders, commercial builders, an individual property owner, a corporate entity, trustee, and real estate investors 140. Depending upon their investment interest (commercial versus residential), different types of real estate investors 140 would constitute a real estate investors database 141 who are only interested in, for example, office buildings as investments. Likewise, depending upon their risk-reward profile, each property owner might be attracted to certain properties listed in the proprietary MLS-like database directory 131 and in particular, those linked to a property tax easement 136—such as a vacant (or non-vacant) lot or post-natural disaster area, because they represent investment opportunities by which they could acquire property tax (call and put) options 138 and use the capital markets 190 to generate profits.

### Another Embodiment: Property Taxes, LLC, and Corporate Entities

Many real estate investors are well aware of the fact that if they move real estate property that they own, for example as an individual or joint tenancy, into a limited liability company (LLC), then the annual property taxes owed on that property can increase—perhaps double or even triple. As such, one embodiment of the present invention envisions that property owners, trustees, trust beneficiaries, and real estate investors will use this fact and seek to advantageously position themselves by buying property tax options 138 prior to any transfer of their real estate property into an LLC, land trust, or any other entity that might trigger an automatic increase in their annual real property taxes paid.

The trustees of an LLC, land trust, partnership, owners of corporations, and other corporate entities which hold real estate assets in the name of a corporate entity, all collectively, thus would be expected to acquire long term property tax put options and long term property tax call options—depending on the ownership status of the real estate assets and the desires of the beneficiaries, trustees, etc. As such, they could serve as the counter-party in any call option and put option exchange transaction and support a viable market exchange for the buying, selling, trading, and exchanging of property tax options 138.

For example, the present invention's proposed solution would provide that all the real estate assets currently being held in the name of the LLC, land trust, business entity, or corporation be transferred out of that entity and into the name of an individual, joint tenancy, or another type of ownership. Prior to the transfer of the real estate assets out of the corporate entity, the trustee of the LLC will have been instructed to buy long term property tax put options. After the tax assessor has performed their job that year, since the real estate property is no longer being held by a corporate entity—but, instead by an individual, then the real estate will most likely not be treated as commercial property. As such, the real property taxes owed should be lower due to the real estate now being held by an individual resultant from a change in the ownership status. Once the new decreased real property tax notice 156 has been issued, then liability attaches to the new individual owner. If there is sufficient difference in the amount of real property taxes owed and it would be favorable for the trustee of the LLC to timely exercise the long put options, then the trustee will do so and collect the profits on behalf of the beneficiaries of the trust.

After receiving any profits, then the process is simply reversed and repeated using long property tax call options on the real estate property. In other words, the individual simply buys long term property tax call options, transfers all of the real estate property out of their individual name and back into the LLC. Upon complete transfer of all the real estate assets, the trustee is instructed to expect an increase in the amount of the annual real property taxes owed due to the new ownership status and the presumption that the real estate will be accordingly treated and taxed as commercial property. The trustee will have been instructed to buy long term property tax call options and wait for the tax assessor 152 to perform their job and raise the real property taxes higher on the same real estate property that is (again) now expected to be treated as commercial property. If there is a sufficient difference in the amount of real property taxes owed and it would be favorable for the trustee of the LLC to timely exercise the long call options, then the trustee will do so and collect the profits on behalf of the beneficiaries of the trust.

Source: https://budgeting.thenest.com/tax-consequences-transferring-property-limited-liability-company-33711.html

### A Further Embodiment: Property & Casualty Insurance Premiums

Likewise, many real estate investors may be well aware of the fact that if they move real estate property that they own, for example as an individual or joint tenancy, into a limited liability company (LLC), then—in addition to their real property taxes, the annual insurance premium charged for a property and casualty insurance policy on the real estate property may also increase significantly because the property is now viewed as being owned by a company and thus the insurer will treat it as commercial property. Therefore, another embodiment of the present invention envisions that property owners, trustees, trust beneficiaries, and real estate investors will use this fact and seek to advantageously position themselves by buying property and casualty insurance premiums (PCIP) options prior to any transfer of their real estate property into an LLC, land trust, or any other entity that could trigger an automatic increase in the amount of their annual real property insurance premium fees.

As disclosed by the present invention's example of using annual real property taxes owed related to a parcel of real estate, property and casualty insurance premiums would work in a similar manner.

Accordingly, the present invention envisions that all real estate assets currently being held in the name of the LLC, land trust, business entity, or corporation would be transferred out of that entity's name and into the name of an individual owner, joint tenancy, or another type of ownership. Prior to the transfer of the real estate assets out of the corporate entity, the trustee of the LLC will have been instructed to buy long term PCIP put options. After the tax assessor 152 has performed their job that year, since the real estate property is no longer being held by a corporate entity—but, instead by an individual, then the real estate will most likely not be treated as commercial property. As such, the annual PCIP owed should be lower due to the real estate now being held by an individual resultant from a change in the ownership status. Once the new decreased real property tax notice 156 has been issued, then liability attaches to the new individual owner. If there is a sufficient difference in the amount of annual PCIP owed and it would be favorable for the trustee of the LLC to timely exercise the long term PCIP put options, then the trustee will do so and collect the profits on behalf of the beneficiaries of the trust.

After receiving any profits, then the process is simply reversed and repeated using long PCIP call options on the real estate property. In other words, the individual simply buys long term PCIP call options, transfers all of the real estate property out of their individual name and back into the LLC. Upon complete transfer of all the real estate assets into the LLC, the trustee is instructed to expect an increase in the amount of the annual PCIP owed due to the new ownership status and the presumed treatment that the real estate will be accordingly taxed and treated as commercial property. The trustee will have been instructed to buy long term PCIP call options and wait for the tax assessor 152 to perform their job and send a real property tax notice 156 reflecting the higher real property taxes higher on the same real estate property that is (again) now expected to be treated as commercial property. Upon the property and casualty insurance carrier receiving the same notification, then an increase in the PCIP should occur and be expected. If there is a sufficient difference in the amount of the PCIP owed and it would be favorable for the trustee of the LLC to timely exercise the long PCIP call options, then the trustee will do so and collect the profits on behalf of the beneficiaries of the trust.

The trustees of an LLC, land trust, partnership, owners of corporations, and other corporate entities which hold real estate assets in the name of a corporate entity, all collectively, thus would be expected to acquire long term PCIP put options and long term PCIP call options—depending on the ownership status of the real estate assets and the desires of the beneficiaries, trustees, etc. As such, they could serve as the counter-party in any call option and put option exchange transaction and support a viable market exchange for the buying, selling, trading, and exchanging of PCIP options. It is envisioned that a PCIP option could also serve as the underlying of a property tax option 138 (and vice versa).

A similar process is envisioned and can be performed with respect to life insurance policies and their life insurance annual premiums. The advantages of having a life insurance premium option (“LIPO”) can be provided in a later patent application with more details as to how this embodiment is actually quite similar to the treatment of “vacant property” (or “non-vacant property”) and real estate property that has undergone capital improvements and resulted in higher real property taxes.

### An Additional Embodiment: Blockchain Technology and Cryptocurrency

Another embodiment which the present invention envisions is the use of blockchain technology to facilitate accepting and using digital cryptocurrency, for example—bitcoin, as a cost-effective and efficient means of performing monetary exchanges related to the buying, selling, trading, and exchanging of real estate, property tax options 138, property tax easements 136, property tax refunding services, and other real-estate related services.

Source: https://www.realcomm.com/advisory/738/1/what-is-blockchain-and-how-does-it-apply-to-real-estate

Typically, real property tax information is kept, recorded, and maintained on a given real estate property in the records or computer database of the local county or municipality where the property exists. Local tax authorities such as the tax collector 154 and tax assessor 152 by and large focus on the tax administration process—and in particular, their main duties are directed to the levy and collection of real property taxes and assessments related to real estate property. Property owners may attempt to lower their annual real property taxes owed by filing an appeal—however, if this is unsuccessful, then they may have to resolve their dispute legally by filing a lawsuit. This consumes a large amount of time, energy, and resources by both parties and is thus not a cost-effective or efficient process. Occasionally, a taxpayer may file a request and/or receive an unexpected tax credit or refund for overpayment of their taxes. However, most property owners do not expect or anticipate receiving a refund or rebate of their real property taxes. Nor have they considered or viewed real property taxes as a type of investment opportunity.

According to one source, it is claimed that:

“Blockchain will enable every property, everywhere, to have a corresponding digital address that contains occupancy, finance, legal, building performance, and physical attributes that conveys perpetually and maintains all historical transactions. Additionally, the data will be immediately available online and correlatable across all properties. The speed to transact will be shortened from days/weeks/months to minutes or seconds.—Jason Ray, Nov. 2, 2015.
Source: httpsJ/www.linkedin.com/pulse/blockchain-cre-its-all-speed-transact-jason-ray

According to a different source (see below), “over $500 billion is collected in the US each year in local/state property tax revenues” and this is consistent with what the National Tax Lien Association (“NTLA”) organization has found. This predictable, reliable, steady source of cash flow represents an attractive investment opportunity for most investors. The present invention envisions an investor being able to potentially obtain a refund or rebate of their real property taxes by using property tax options 138, the capital markets 190, and the strong tendency for local governments to exercise their sovereign power and authority and raise taxes on vacant land that has undergone capital improvements. Although there are periods of boom and bust related to economic growth. Nevertheless, throughout every business cycle, history has shown and the present invention envisions that the function of levying and collecting property taxes by the government is an ongoing process and this type of activity will continue each and every year.

Source: https://www.cnsnews.com/news/article/540701000000-us-property-taxes-hit-record-2016

Taxes are imposed by these taxing jurisdictions on the total and partial ownership interests in real property such as land, building, and permanent improvements. If, and when, the expected taxes are not paid and they become delinquent, then this usually results in the public debt being sold. According to the FAQ section of the NTLA in response to the question, “How does the novice investor find tax lien investing opportunities?” the response given was that “some 2,500 jurisdictions (cities, townships, counties) [currently] sell public tax debt.”

Source: http://www.ntla.org/?page=FAQ

Finally, a third source claims that:

By offering a 100 percent incorruptible resource, whereby the sender and recipient of funds was logged, and where “digital ownership certificates” for properties are saved, the blockchain would effectively make forged ownership documents and false listings a thing of the past. The unique “digital ownership certificates” would be almost impossible to replicate, and would be directly linked to one property in the system, making selling or advertising properties you don't own almost impossible.—Don Oparah, Feb. 6, 2016
Source: http://techcrunch.com/2016/02/06/3-ways-that-blockchain-will-change-the-real-estate-market/

The present invention argues for the premise that there doesn't appear to be much or any concerted effort put forth by the federal, state, or local government in striving to provide consumers and property owners a refund or rebate of their annual property taxes paid.

The present invention envisions a unique opportunity to use the capital markets 190 as an attractive means of delivering these “lost” funds back into the hands of the consumers, businesses, and owners of real estate property. The disclosed embodiments may be ways to best achieve the objectives of the proposed invention.

Whether one is a real estate investor who loves to fix and flip houses, a seasoned tax lien sales certificate investor in search of an attractive investment opportunity, or a new commercial or residential builder just entering the competitive real estate and construction industry—they all face the same challenging situation under the current traditional tax administration system. He who owns the property pays the real property taxes. How does one create a sustainable, reliable, predictable residual income stream from each and every property that a builder, investor, or realtor builds, flips, or sells? The present invention is intended to address this question.

The present invention discloses that the annual real property taxes associated with real estate property, property tax easements 136, property tax options 138, and the capital markets 190 can be combined into a system to create an attractive investment opportunity. By combining the ideas and embodiments expressed in the present invention with a cryptocurrency and the blockchain technology, a system can be envisioned that is a more streamlined, cost-efficient, transparent, cost-effective process that leverages disintermediation and results in lower transaction costs, cost-savings, reduced fraud, and enhanced trust between the parties engaged in a transaction while preserving the anonymity of each party. The opportunity to examine and use other alternative ways to achieve similar, if not better results compared to the existing tax administration system, would be advantageous for consumers, property owners, the government, and all real estate and capital market participants.

### Another Embodiment: Property-Specific Geographic Address Trademark

As a non-limiting example of this embodiment, a business opportunity is implemented as a franchise business model and that an individual is a prospective franchisee who:
owns and lives in a residential home physically located at 123 Main Street, Anytown, N.Y.;
owns a vacant lot that is physically located at 456 Main Street, Anytown, N.Y.; or
owns a parcel of commercial real estate that is physically located at 789 Main Street, Anytown, N.Y which has a commercial building on it.
   The individual can have a “property-specific geographic address trademark” 199 (or “property-specific geographic address service mark,” if applicable) for each of these separate, distinguishable, identified, type, and parcel of real estate.

Under the franchise agreement, the individual could, for example, be granted, the right to hire someone to create up to three (3) related or similar trademarks, one for each type of real estate property which the individual currently owns.

For example, a property-specific geographic address trademark 199 could be:
330pieR which is designated for the residential home physically located at 123 Main Street, Anytown, N.Y.;
330pieV which is designated for the vacant lot that is physically located at 456 Main Street, Anytown, N.Y.; or
330pieC which is designated for the property that is physically located at 789 Main Street, Anytown, N.Y which has a commercial building on it.
   An application to register each of these property-specific geographic address trademarks 199 with the State of New York and/or with the United States Patent and Trademark Office (U.S.P.T.O.) could be submitted by the franchisor on behalf of the franchisee—and if approved for state and/or U.S.P.T.O registration, then the marks could later be assigned to the franchisee based upon certain criteria being met (i.e., having a clear title and proof of ownership for each property).

Each trademark could seek registration under, for example, Class 41, that describes:
the 330pieR mark as being used to “provide educational services to the general public about the creation and use of intangible assets exclusively related to residential real estate property;”
the 330pieV mark as being used to “provide educational services to the general public about the creation and use of intangible assets exclusively related to vacant real estate property;” and
the 330pieC mark as being used to “provide educational services to the general public about the creation and use of intangible assets exclusively related to commercial real estate property.”

Assuming that these trademarks are approved for registration, then each of them can be used in conjunction with the inventor's business and enhance the value of his federally registered trademark, PROPERTY TAX EASEMENT, that is devoted to providing “Financial services, namely the management and investment of real property owners' property taxes.”

As part of the franchise package, legal services could be obtained by the franchisor to:
draft and prepare a Property Tax Easement contract for the individual to sign that would subject their properties to it;
draft and prepare a license Agreement giving the individual limited rights to use the patent to create a Property Tax Easement; and/or
draft and prepare a separate license agreement to give the individual limited rights to use or make a trademark that is similar to the federally registered trademark “PROPERTY TAX EASEMENT.”

The individual/franchise owner could choose to use their residential home or the property that has the highest paid annual property taxes as the place of business for their franchise.

Under the current existing tax laws, the value of different types of assets used in a business can be amortized or depreciated over a certain period by the owner of these assets.

It is believed that both the two (2) license agreements, as well as the three (3) trade marks, would all qualify as intangible assets used in the franchise owner's business—each with their own valuation.

These laws give owners the right to claim and take amortization and depreciation expenses related to the value of all of their intangible and tangible assets.

This results in lower taxable income and ultimately fewer taxes having to be paid by the owner on earned income and revenue generated by their business.

In some cases, net income losses (NILs) are created which can be used as a loss carryback and loss carryforward and thus provide the owner favorable financial accounting, tax, and economic benefits.

It is to be understood that the present invention is not limited to the embodiments and non-limiting examples described above or as shown in the attached figures, but encompasses any and all embodiments within the spirit of the invention.

What is claimed is:

1. A system for refunding real property taxes using a plurality of easements and a plurality of real property tax option contracts, said system comprising:
a real property tax refund program joined by a plurality of parties associated with a plurality of real property lots; and
a computer-related database having the capability to compile and list said plurality of real property tax option contracts as a plurality of intangible assets that may be bought, sold, and/or traded on a trade exchange,
wherein a real property tax easement on each of said plurality of real property lots is granted by a corresponding party of said plurality of parties associated with said plurality of real property lots for the purpose of creating said plurality of real property tax option contracts,
wherein said plurality of real property lots are adapted for serving as underlying instruments or securities for the purpose of linking them to said plurality of real property tax option contracts,
wherein each of said real property tax option contracts has a strike price about equal to an annual real property tax amount owed to a tax collection authority;
wherein a transaction party is able to make a transaction on at least one of said real property tax option contracts,
wherein each of said real property tax option contracts is selected from the group consisting of a long naked call contract and a put option contract,
wherein a real property tax bill showing an amount of tax owed for next year by said one of said plurality of parties associated with said plurality of real property lots may be received;
wherein the real property tax bill may be paid to a tax collector by the transaction party, and
wherein a real property tax option prior to its expiration date may be exercised and potential profits may be possibly split among at least one entity in a corresponding party of said plurality of parties associated with said plurality of real property lots.

2. The system according to claim 1, wherein said database is a proprietary Multi-Listing Subscription (MLS)-type database and/or printed directory.

3. The system according to claim 1, wherein said database comprises at least one of a computer server, a software program, a network, a user interface, and electronic database.

4. The system according to claim 1, wherein said trade exchange is a publicly-traded exchange.

5. The system according to claim 1, wherein at least one of said plurality of real property tax option contract is a call option contract, and wherein a buyer of said call option contract will have a right but not an obligation to buy an underlying stock at said strike price or exercise price and will exercise a call option whenever the stock price is higher than said exercise price.

6. The system according to claim 1, wherein at least one of said plurality of intangible assets is a real property tax easement agreement.

7. The system according to claim 1, wherein at least one of said plurality of intangible assets is a property-specific geographic trademark.

8. The system according to claim 1, wherein each of said plurality of parties associated with a plurality of real property lots is at least one individual selected from the group consisting of a property owner of a property lot and a builder of said property lot.

9. A method for refunding real property taxes using a plurality of easements and a plurality of real property tax option contracts, said method comprising the steps of:
providing to a plurality of parties associated with said plurality of real property lots with opportunities to join said real property tax refund program;
granting a real property tax easement on each of said plurality of real property lots for the purpose of creating said plurality of real property tax option contracts as a plurality of intangible assets that may be compiled on or in a database and bought, sold, and/or traded on said trade exchange;
linking each real property tax easement to a real property tax option contract of said plurality of real property tax option contracts,
wherein said plurality of real property lots are adapted for serving as underlying instruments or securities for the purpose of linking them to said plurality of real property tax option contracts,
wherein each of said real property tax option contracts has a strike price about equal to an annual real property tax expected to be owed;
making a transaction on at least one of said real property tax option contracts by a transaction party,
wherein each of said real property tax option contracts is selected from the group consisting of a long naked call contract and a put option contract;
receiving a real property tax bill showing an amount of tax owed for next year by said one of said plurality of parties associated with said plurality of real property lots;
paying the real property tax bill to a tax collector by the transaction party; and
exercising real property tax option prior to its expiration date and possibly splitting potential profits among at least one entity in a corresponding party of said plurality of parties associated with said plurality of real property lots.

10. The method according to claim 8, wherein said database is a proprietary Multi-Listing Subscription (MLS)-type database and/or printed directory.

11. The method according to claim 8, wherein said database comprises at least one of a computer server, a software program, a network, a user interface, and electronic database.

12. The method according to claim 8, wherein said trade exchange is a publicly-traded exchange.

13. The method according to claim 8, wherein at least one of said plurality of real property tax option contracts is a call option contract, and wherein a buyer of said call option contract will have a right but not an obligation to buy an underlying stock at said strike price or exercise price and will exercise a call option whenever the stock price is higher than said exercise price.

14. The method according to claim 8, wherein at least one of said plurality of intangible assets is a real property tax easement agreement.

15. The method according to claim 8, wherein at least one of said plurality of intangible assets is a property-specific geographic trademark.

16. The method according to claim 8, wherein each of said plurality of parties associated with a plurality of real property lots is at least one individual selected from the group consisting of a property owner of a property lot and a builder of said property lot.

17. A method for refunding real property taxes using a plurality of easements and a plurality of real property tax option contracts, said method comprising the steps of:
creating an account and acquiring at least one real property tax call and/or put option related to real estate property by a party associated with a real property lot;
deciding how much simple interest they are willing to pay an investor by said party associated with a real property lot;
calculating their average annual property tax bill from the past certain number of years by said party associated with a real property lot;
funding their account by placing certain number of years worth of real property taxes into an account in addition to a certain amount of simple annual interest by said party associated with a real property lot;
at least one investor looking for a good investment that pays a certain simple annual interest;
the at least one investor contributing a certain number of years worth of real property taxes owed to account of said party associated with a real property lot;
receiving higher property tax notice from a tax collector due to market appreciation and/or capital improvements by said party associated with a real property lot;
paying their property tax bill to the tax collector for real property taxes owed by said party associated with a real property lot;
providing proof of real property taxes paid provided from the tax collector office to the investor;
exercising real property tax option and splitting profits between investor and said party associated with a real property lot;
investor receiving their annual simple interest and their principle back from said party associated with a real property lot; and
receiving a refund of their paid real property taxes from the investor's account and/or the capital markets by said party associated with a real property lot.

18. The method according to claim 17, wherein each of said plurality of parties associated with a plurality of real property lots is at least one individual selected from the group consisting of a property owner of a property lot and a builder of said property lot.
